(19) United States
(12) Patent Application Publication
(10) Pub. No.: US 2022/0081019 A1
(43) Pub. Date: Mar. 17, 2022

(54) Multifunctional bassinet and multi-function cradle bed and matching card slot equipment

(71) Applicant: HUA YE, Hangzhou (CN)

(72) Inventor: HUA YE, Hangzhou (CN)

(21) Appl. No.: 16/873,385

(22) PCT Filed: Aug. 31, 2018
(86) PCT No.: PCT/CN2018/000309

§ 371 Date: Jun. 1, 2021

(30) Foreign Application Priority Data
Aug. 30, 2017 (CN) 201710824774.X
Aug. 21, 2018 (CN) 201810985198.1
Aug. 23, 2018 (CN) 201810986273.6

(51) Int. Cl. B62B 9/00; B60N 3/00; A47D 11/00; B62B 7/12; B62B 9/08; B62B 9/18; B62B 9/22; B62B 5/00

(52) U.S. Cl. CPC B62B 9/00; B60N 3/008; A47D 11/005; B62B 7/12; B62B 9/14; B62B 9/18; B62B 9/22; B62B 5/0036; B62B 9/08

(57) ABSTRACT

Provided are a multi-functional perambulator, a multi-functional cradle bed, a multi-functional infanette and a multi-functional baby carriage, wherein same are all mounted with spring clamping slots (80, 3319). Also provided is a novel multi-wheel walking device. Further provided are a smart wrist band and a smart watch, wherein both of same have a real-time payment system, may be used for a user of a perambulator, a cradle bed, a multi-functional infanette and a multi-functional baby carriage to make a payment when shopping in various supermarkets, facilitates shopping for the user, and satisfies the requirements of the user.

### FIELD OF THE INVENTION

The invention relates to a plurality of card slot type appliances, comprising a multifunctional cradle and a multifunctional cradle bed and a crib and a baby carriage and an air conditioner electric vehicle and a matching card slot type thereof Shared viewing utensils,

### BACKGROUND OF THE INVENTION

There are a variety of multi-functional cradle and cradle beds and cribs and strollers currently available on the market, but none of them can be slip-proof on supermarket ramp escalators, which can be disassembled and folded and compressed, and installed with air conditioners, with a tablet, can be shared, a horn, a fan, a cradle or a cradle or a cot or a stroller that can go up and down the stairs, and no one can be installed in the above-mentioned cradle through the card slot. The utility model relates to a cradle bed or a crib or a viewing device on the stroller, which brings inconvenience to the people's life. The present invention introduces a multifunctional cradle, a cradle bed, a crib, a stroller, all of which can solve the above problems. It can be non-slip on the ramp escalator, can also climb stairs, has built-in voice-activated music player and switch control external, and can change the content at any time through the data interface, and can be used by the user according to the instruction manual. Ordinary simple tool (no need for additional equipment) such as a screwdriver to change to a walker or a fixed cradle or storage closet or a multi-functional shake of a baby bed or trolley The cradle bed of the present invention refers to a cradle bed having a bottom walking device, and is a movable cradle bed with a wheeled walking device or a crawler type walking device, the structure of which can be The side plates of the large basket of the bassinet according to the schemes 1 and 3 are laid flat to form a bed board, and the cradle and the like can be disassembled, and the use can be changed. The crib of the present invention can be solved by the technical schemes 1, 3 After the basket of the big basket of the bassinet is laid flat, the cradle is disassembled, and the stroller of the present invention can be disassembled by the cradle of the bassinet mentioned in the technical schemes 1, 3, the stroller. The cradle with the crib and the cradle bed and the cradle can be disassembled or folded at any time, because the cradle can be hooked to the inside of the cradle or the cradle bed, and the viewing tool of the present invention, is a tool for placing flowers, the technical scheme of which is shown in FIG. 26,

### SUMMARY OF THE INVENTION

The object of the present invention is to provide the following technical solutions

1, the first technical solution, the crawler type detachable multifunctional cradle, the structure is as shown in FIG. 1, which is a new type of multifunctional cradle, specifically, a cradle inside, and a large basket and can be changed to a cradle bed cradle having a crawler type walking device, which also has a supermarket shopping cart wheel (ie, wheel 9), the structure of which is shown in FIG. The reference numerals of 9 are as follows, 3318 points to the connection, 36 points to the wheel shelf, 333 points to the wheel base, 337 points to the supermarket automatic ramp, which can also be equipped with anti-slip devices (reference numeral 29), brake shoes (reference numerals 501), support foot (reference numeral 509), spring card slot (reference numeral 80), real-time payment device (reference numeral 331), drag basket (reference numeral 240), large basket (attached) The figure is marked 24), small light (reference numeral 25), sun shield (reference numeral 37), horn (reference numeral 10011), air conditioner (reference numeral 709), motor (reference numeral 3 or 3301), adapter, battery (reference number 30 or 3001), etc., the bassinet is also inside Players and speakers, and sub tablet vehicle body, the bassinet may be provided with a computer processing system. The system is equipped with a central processing unit, through which the user controls the bassinet, the display screen and the switch controller are externally connected to the outer surface of the bassinet, and the user can change the playing content at any time through the player data interface, and the user also The cradle can be controlled directly by pressing the switch on the radiation, and the cradle can be driven directly by means of power conversion to mechanical energy without using a computer. If the user disassembles the motor and reduces the size of the body, the user can use the cradle. Make room for yourself and change to a walker. If you expand the size of the car body, you can turn it into a baby bed frame. If you pull the car up, you can become a storage wardrobe. The height and length of the car can pass. Adjusting screw control, the player can be manually switched. As an improvement, the user can change the length, width and height of the car body according to the instruction manual. The anti-mosquito sunscreen canopy and sunshade and handrail can be disassembled and cleaned. Covering all the bodywork, whether it is the cradle bed or the cradle or the air-conditioned electric vehicle mentioned in this case, there is a sunshade cover, but this sunshade does not affect the car. Sealing is performed, the front part of the sunshade is provided with a vent, the side of the sunshade can be attached with a zipper door or a cassette (reference numeral 3399), and the cradle is provided with a card slot (reference numeral 3319) (The card slot is a card slot specially used for locking the card head. It is not the same as the card slot inserted into the real-time payment device, not a structure, so the reference numerals are different.) The sunshade should be on the bassinet. Insert the sunshade clip into the slot on the bassinet to fix the sunshield. The sunshield can form a separate enclosed space inside the car body, but it is not a sealed space. It is equipped with a vent and a sunshield. As a cover cover on the outer surface of the bassinet (or cradle bed), the outer surface of the vehicle body (reference numeral 3322) is fitted with a card slot (reference numeral 3319), which can be used with the card head of each side of the sunshade (The reference numeral is 3399), the locking is locked. When the user needs to cover the sunshade on the cradle bed or the cradle, only the card hoe is inserted into the inside of the card slot, and the two are locked and locked with each other. The sunshade becomes a a cover covering the entire body (or cradle bed), the cradle is equipped with a miniature or small air conditioner (reference numeral 709), and the air conditioner (in the summer, the cold air discharged from the sun hood or the winter is taken inward) The cold air or hot air discharged from the air outlet (reference numeral 708) of the hot air is less likely to leak to the outside of the sunshade, and the motor is mounted on the lower part of the bass car, and the motor (reference numeral 3) is The battery (reference numeral 30) is powered, and the battery is also powered by a rocker (reference numeral 66). The working principle of the 2 hydraulic system is common knowledge, and the working principle of the rocker is well known. Similar to the rocker on the crank or rocking chair, it can be used for the swinging cradle (reference numeral 7). The motor has electric power to push the car body under the operation of the user. The rocker has the power provided by the battery. Under the control of the user, it can be used for the swinging cradle. The control switches are all arranged on the armrest (reference numeral 15). The bottom of the bassinet can be equipped with a crawler walking device or multiple wheeled walking. Device, said shaking Inside the car, there is a large basket that can be retracted. When the side panels of the large basket are lowered into a horizontal state, the large basket becomes a bed plate, and the user can also lower the support legs on the frame of the bass car through the control button. Supporting the bassinet with the supporting foot instead of the walking device, the cradle becomes a fixed cradle bed, and the side panel of the large basket (reference numeral 24) is lowered, so that a bed can be made, and the user can disassemble the cradle. Let the baby sleep directly on the mattress of the bedboard. Thus, the bassinet becomes a crib, and the cradle can be kept, so that the baby can sleep in the cradle. There is a double arrow in the middle of FIG. 1 to indicate the large basket side panel. In the direction of retracting, the side panels of the large basket are put away, then the bed board becomes a large basket. The inside of the big basket can be put into the merchandise, the cradle bed becomes a cradle, the side panels of the big basket are put down, and the cradle is disassembled, which can be large. When the basket becomes the bed of the crib, the bassinet becomes a crib. After the sideboard is lowered, the cradle is retained, and the cradle becomes a cradle bed. There is a spring card slot on the frame of the cradle (reference numeral For 80 The spring card slot can be inserted into a real-time payment device according to the present invention (it is a smart phone with an instant payment system installed, and has a button payment button on the side, which has a one-click payment function when the user When the one-click payment button is pressed, the payment interface will appear on the screen, and the user clicks on the screen to select active payment or passive payment. If the payment is made actively, the payment code will appear on the screen for the merchant's scanner to scan, such as passive payment, the scan box will appear on the screen (such as the scene of the mobile phone camera lens displayed by the mobile phone camera), the user will scan the scan box to the merchant's payment code, and scan the merchant payment code payment through the camera of the real-time payment device. The interior of the bassinet is provided with a micro air conditioner having a reference numeral 708 for the inner air outlet, 710 for the outer air outlet, 709 for the air conditioner, and a large basket for the interior of the bass basket. This large basket is labeled 24, the buzzer or speaker of the bassinet is labeled 13 and the large basket has a tow basket* (reference number 240), which is a An object that can be used independently, with a crawler-type walking device installed in the lower part, or a multi-wheeled traveling device, with wheels 9-0 (a wheel that is the same as the wheel 9 but smaller than the wheel 9), a tow basket or The large basket has a pull ring (reference numeral 33), a tow basket or a large basket and a drawbar (reference numeral 35). In the technical solution shown in FIG. 26, the bass basket cradle bed or baby A joystick (reference numeral 213) can be set on the car, a control panel can also be mounted on the joystick, or a control panel (reference numeral 2) is provided on the armrest or the tie rod, the pull rod is connected to the pull ring, and the lower part of the large basket A multi-wheeled walking device can be installed, which is equipped with wheels 9-0 (a small wheel 9) and a small crawler type walking device, and the large basket or the tow basket itself can be used independently as a vehicle.

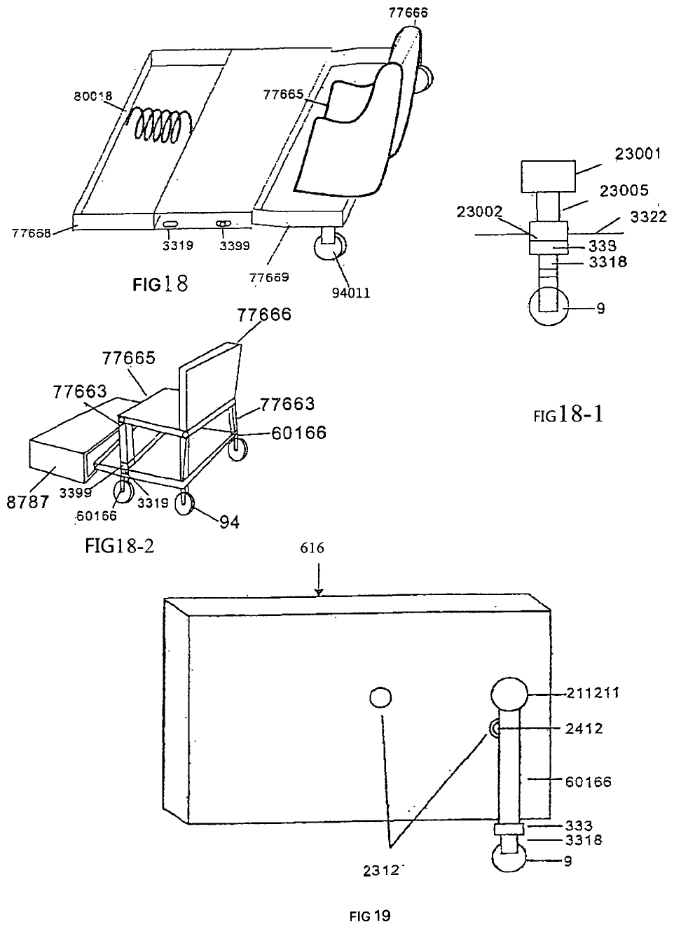

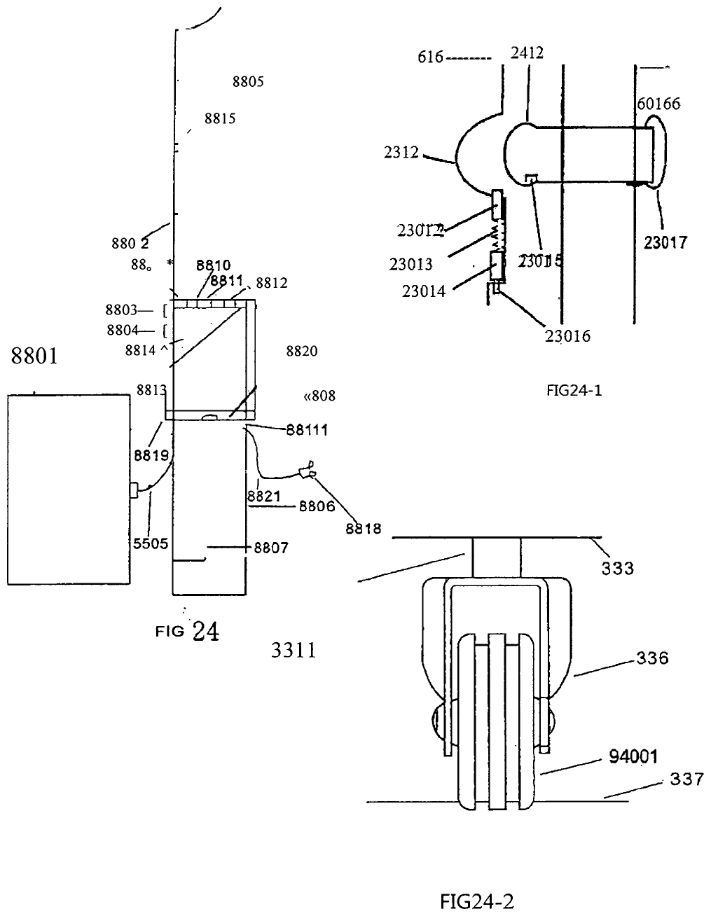

The lower part of the large basket is also provided with wheels 9-0, crawler type walking device or multi-wheeled walking device. The four side plates of the large basket can be put down as a bed for the crib, large basket (labeled 24), and the basket It can also be equipped with an air conditioner and a rocker and an electric motor and a battery, a basket and a large basket, which are two technical solutions of the present invention, and a small crawler type walking device can be installed at the bottom (the crawler type walking device at the bottom of the large basket) Marked as 2221, the crawler type walking device at the bottom of the basket is labeled 222111) and the wheel 9-0, and the multi-wheeled traveling device can also be installed (that is, the left and right train wheels are arranged asymmetrically, and the small basket is installed at the bottom of the small basket). The supermarket cart wheel is labeled 9-0, the small supermarket cart wheel at the bottom of the basket is labeled 9-4), and the large basket or basket can be fitted with miniature air conditioners and batteries with miniature swings. The device (reference numeral 6666) and the miniature motor (reference numeral 3303), the wheel 9 can be linked according to the connection mode of the supermarket shopping cart wheel and the supermarket shopping cart, or the wheel 9 can be connected. The connecting post (reference numeral 3318) is fixed to the wheel base, the lifting device (reference numeral 615) fixed to the bottom of the bassinet or the bassinet bed, or the connection fixed to the rotating device (reference numeral 616) On the rod, the rotating device means that a screw that can rotate back and forth (reference numeral 60166) is installed at the bottom of the bassinet or the cradle bed, and one end of the screw is screwed to the screw hole to fix it to the bassinet or On the support post (reference numeral 616) at the bottom of the cradle bed, the other end of the screw is fixed to the wheel seat of the wheel 9. When the user wants to enter the supermarket, when the automatic ramp is to be carried out, the wheel 9 is lowered, and the screw is turned from the horizontal position to the vertical position by using the manpower, so that the wheel 9 fixed on the screw is horizontally placed and placed vertically. Then, the wheel 9 touches the ground, and the cradle and the like do not slip on the automatic ramp. When the user has left the supermarket, the screw is turned, the wheel 9 is changed from vertical to horizontal, and the screw passes through the screw (reference numeral 211211) fixed inside the screw hole of the support column, the screw has a spring positioning strip, one end of which is fixed to the inside of the screw, and one end is a spring switch of the spring fixing head when the positioning head (reference numeral 2412) is used. (reference numeral 23016), the spring fixing head of the positioning hole (reference numeral 2312) is retracted, and the positioning head is inserted into the positioning hole. After entering, the spring fixing head is loosened, and the fixing head is inserted into the notch of the positioning head (Fig. Marked as 23015), the fixed figure catches the positioning head, thereby fixing the position of the screw. If the screw is to be rotated, the user pushes the spring switch of the fixed head, and the fixed head exits the notch of the positioning head. The head exits the positioning hole, the positioning head corresponds to two positioning holes on the support column, and one positioning hole is at the upper part of the support column (reference numeral 616). When the screw is in the horizontal position, the spring latch is just embedded in the 5 horizontal positioning. Inside the hole (reference numeral 2312), the other positioning hole is in the lower part of the support column. When the screw (reference numeral 60166) is in the vertical position with the wheel 9, the positioning head on the screw is just embedded inside the hole, the spring positioning head The head has a circular notch (reference numeral 23015), a middle spring is fixed inside the screw, the tail end is exposed on the outside of the screw, and the structural diagram of the positioning head and the spring fixing head is shown in FIG. 24-1. Positioning the inside of the hole to achieve the purpose of changing the position of the wheel 9, thereby realizing the rotation of the wheel 9. The structural view of the turning device is shown in FIG. 19, and the structure of the locking device of the turning device is shown in FIG. 24-1.

Said Invention

The battery can supply power to the motor, the motor drives the wheel of the multi-wheeled traveling device, the battery can also supply power to the rocker, and the rocker can swing the cradle with power. The cradle reference numeral 7 of the present invention is

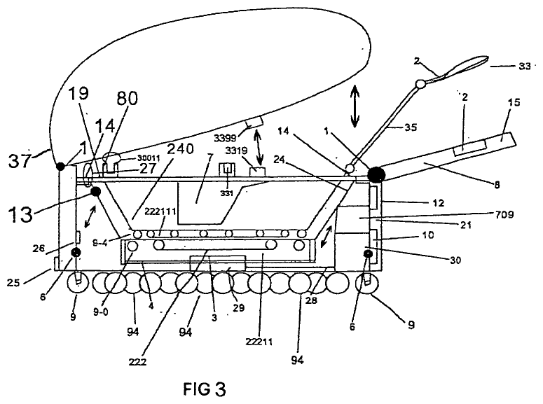

The wheel type detachable multifunctional cradle bed has the structure as shown in FIG. 3, and the technical scheme thereof is as follows.

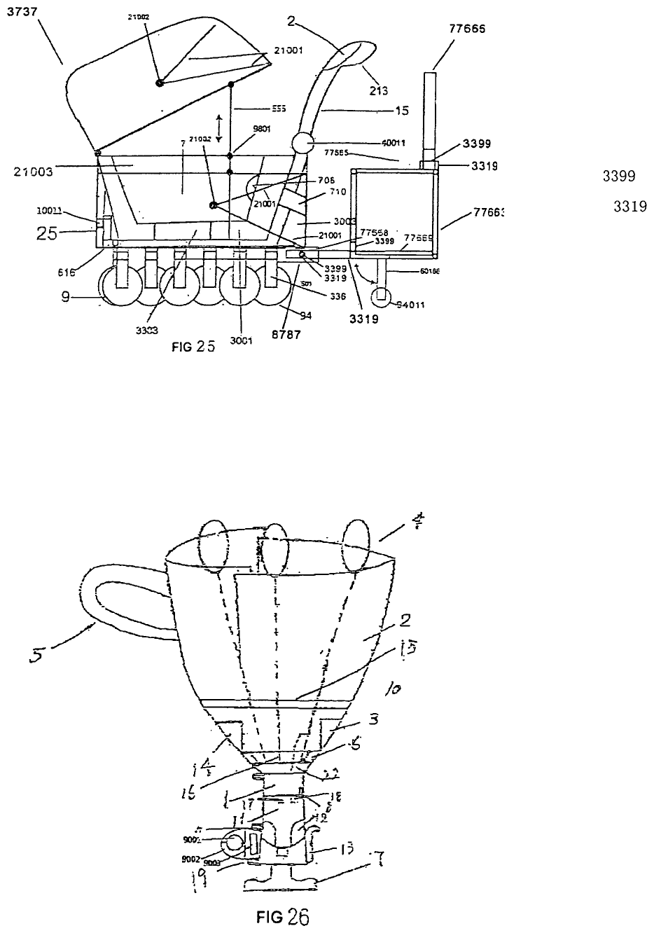

The main technical features are the same as the above-described technical solution 1, except that the traveling device is changed from the half-track type traveling device of the first aspect to the multi-wheel type traveling device, and the traveling device has the following technical features. It has two or more train wheels (reference numeral 94) which are mounted in an asymmetrical manner to each other. The side view after installation is shown in FIG. 3, FIG. 5, FIG. 25, after installation. The undercarriage chassis is shown in FIGS. 8-1, 22, and the wheels are referenced 94, which are mounted separately, ie each wheel (referring to the wheel labeled 94 or 94011 or 94012, The wheel of the multi-wheeled traveling device of the bassinet or the cradle bed of the present invention is designated as 94, and the wheel of the multi-wheeled traveling device of the large basket is referenced to 94011, and the multi-wheeled traveling device of the towing basket The wheels are 94012, and these wheels are all connected by a spring column (reference numeral 3311) or a spring with its wheel base (reference numeral 333), and are screwed through the screw hole and the nut to make the wheel seated. At the bottom of the car body, a shock spring column or a shock absorbing spring (reference numeral 3311) is fixed between the wheel base and the wheel frame, and the wheel frame (reference numeral 336) is fixed with the screw of the wheel and the screw hole on the wheel. Connection, the wheel of the present invention, as indicated by reference numeral 9 or reference numeral 9-0, or reference numeral 94, or reference numeral 9-4, or reference numeral 94011 or reference numeral The wheels of 94012, 94001 can be rotated. The above wheel can be a universal wheel. The spring column is a connecting column with a built-in damping spring. It is a spring damping tube. As an improvement, the wheel can be directly connected by a shock absorbing spring. The top end of the frame and the wheel seat body, and the cylindrical tube is omitted, in other words, the 3 wheel frame fixedly connected to the wheel can be directly connected with the wheel base by a spring, and as an improvement, the inner side of the wheel frame can be disassembled. The limit block, the limit block can be raised and lowered, the reference block of the limit block is 3409, and the limit block can make the wheel which is originally a universal wheel (as indicated by the reference numeral 94, 9, 9-0, 9-Horizontal rotation of 4,94012,94011) Limited to, such as only about 15 degrees or 30 degrees,

A multi-wheeled walking device can also be installed at the bottom of the large basket or the tow basket, and the wheel is a small wheel (reference number 94011 or 94012, respectively).

For how the electric motor drives the crawler type walking device and the wheeled traveling device, the following is explained.

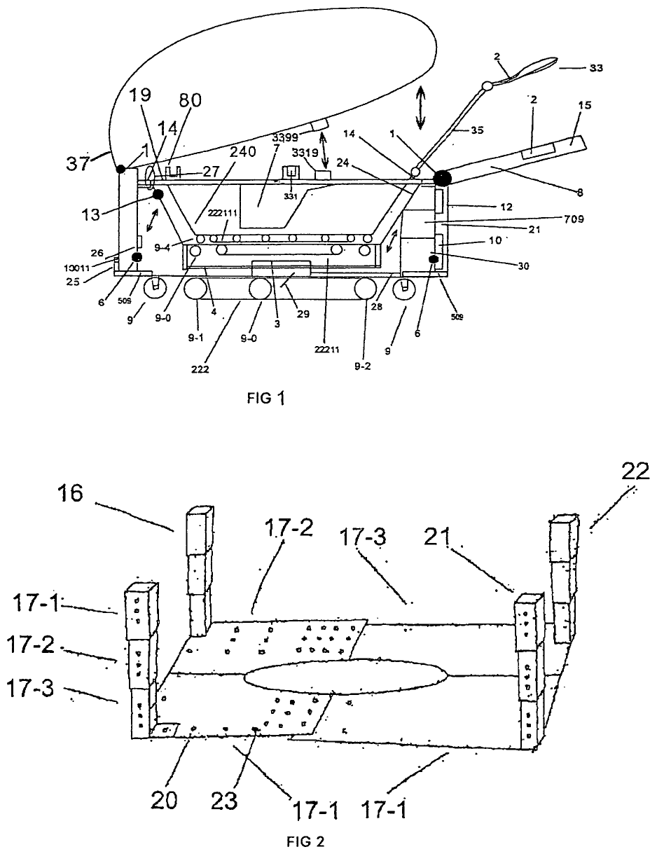

Referring to the basic common sense, the crawler type walking device of the present invention can work according to the working principle of the known electric crawler type traveling device. The technical solution of the present invention can simultaneously install the crawler type and multi-wheel type walking device, and two kinds of walking. The device is installed on the two landing gears, and the landing gear is connected to the hydraulic lifting system. The user controls the hydraulic device to raise or lower the tracked or multi-wheeled walking device. It can also work according to the following working methods. The system can accept voice control, said wheels set inside the track, such as wheels 9-1, 9-2, which are mounted with axles on one side of the vehicle body, the axles are connected to the swing arm, and the axle sea damper spring phase Connected, the motor drives the wheels 9-1 or 9-2, 9-1 or 9-2 through the transmission to engage the track, thereby driving the track to rotate. The crawler type walking device and the common tracked vehicle (such as a tank, an armored vehicle) The principle is the same, there is a technical solution that the wheeled walking device is directly fixed to the bottom of the vehicle body or the bed body, and the crawler type walking device can be installed in a lever (The figure is marked as 6719) on the frame of the connected bassinet or crib or cradle bed or crib. The middle of the lever is the bracket fixed on the body (reference numeral 6722), and the other end of the lever is mounted on the crawler. On the connecting post (or screw) of the traveling device, an electric motor (for driving the driving wheel of the crawler type traveling device) is mounted on the frame, and a handle is arranged at one end of the lever, and a spring clip head (reference numeral 3399) is mounted on the side of the handle. There is a spring card slot under the handle (reference numeral 3319), press the handle, compress the large spring (reference numeral 6720), insert the handle of the handle into the spring card slot, the handle is fixed to the card slot, the lever is another Pick up at one end and raise the lifting frame (reference number 6711). The crawler type walking device fixed under the lifting frame will be raised. Otherwise, the handle will be lifted, the large spring will be reset, the other end of the lever will fall, and the lifting frame will be lowered and fixed. The crawler type walking device under the lifting frame will be put down, (see FIG. 12-2). This is a type of cradle or crib or cradle bed or stroller of the present invention having both crawler and wheel type. Walking wear The technical solution of the wheel type and the crawler type walking device is, for example, the wheel seat of the wheel 9 can be disposed on the lever fixed to the frame 3322, and the user lifts and lowers the crawler type walking device by means of the lever. The wheel 9, for example, a screw is arranged on the frame, and the screw protrudes from the inner portion of the screw (the thread is internally engaged with the thread on the surface of the screw), and the screw is provided with a nut (reference numeral 5513), which is rotated upward. The nut allows the screw to rise inside the solenoid. Conversely, the screw can be lowered from the inside of the solenoid (reference numeral 5512) because the lower part of the screw is fixed to the frame of the wheel 9 (reference numeral 336). Therefore, the wheel 9 can be lifted and lowered. Referring to FIG. 18-1, the motor of the present invention is powered by a battery, and the motor has an output shaft, and the wheels (94, 94001, 94012, 9-1, 9-2) are There are axles, the axles and the shifting gears are connected to each other, and the motor output shafts of the amateur shifting gears are connected to each other. Thus, after the motor is started, the wheels are driven to roll, and the wheels (94, 94001, 94012, 9-1, 9-2) can also be directly connected to the motor. lose Pumping, s user drives the motor (drive motor) through the switch, the motor drives the wheel (94, 94001, 94011, 94012), the anti-slip device has a piston and a large spring inside, and the anti-slip device is fixedly connected to the chassis, which is hollow tubular The piston is disposed inside, the piston sleeve is disposed inside the large spring, and the bottom of the piston is a tab, when the user sends a command through the control panel or directly pedals the piston pedal. The piston moves downward, the insert protrudes, and is inserted into the groove of the axle to brake the wheel. Referring to FIG. 29, the motor of the present invention is a DC motor connected to the gear box, and the gear box can be connected to the steering gear. Can connect wheels or axles,

Quote,

The principle of the motor-driven crawler type traveling device of the present invention can be either a battery power supply, driving two crawler type tissues with one motor, or one or two battery power supplies, and two crawler type walking devices. There is a motor drive, and its control device (ie, the control box) is a computer (single-chip computer or central processing system). The computer has a user operating through a button (switch) on the control panel of the armrest or the joystick. The following technical solutions,

1, the motor drives the wheel in the center,

The essence of its technical solution is that

A motor can be used to drive the wheels on the left and right sides. The technical solution can be composed of an electric motor, a clutch, a gearbox and a differential. The motor power is connected or powered off by the clutch. The gearbox provides different gear ratios to change the speed-power curve matching. The transmission realizes different speeds of the wheels on both sides when cornering.

The technical solution can also be,

The battery supplies current, and the current is supplied to the motor after being adjusted by the power regulator. When the motor sees the current, the mechanical energy (driving force) is transmitted to the power transmission device or the transmission system (reference numeral 28). The transmission device or the transmission system transmits the driving force to the wheel. (including wheel 9-0, or 9-1, or 9-2, or 9-3, or 94) wheel rolling to drive the tracked gear forward or directly drive the bass or cradle or crib or stroller travel,

2, electric wheel drive,

The essence of its technical solution is.

The electric wheel directly drives the cradle bed or the cradle to move forward or backward.

The technical solution can be,

The single or double motor electric wheel drive mode is adopted, and the technical solution may be that the wheel of the micro motor and the brake drum is directly mounted on the wheel as the wheel 94 or 94001 or 94011 or 94012 of the present invention, which may be The brake drum is mounted on the wheel. The anti-skid device and the brake drum of the present invention can be controlled by the user directly by pressing the switch on the handrail or the joystick, through the wire connected to the brake drum, or by handrail or manipulation. The switch on the pole (the switch is connected to the control box, and the control box is connected to the motor) is controlled by electric manipulation. No matter which kind of brake switch the user presses, all the power will be cut off at the same time.

That is, the wheel 9-2 (one on each side) of the crawler type traveling device according to the present invention is an electric wheel, or a wheel of a multi-wheel cradle bed or a multi-wheeled cradle according to the present invention (attached) In the middle of the figure, 94 or 94011 or 94012), one wheel on each of the left and right (reference numeral 94 or 94011 or 94012) is an electric wheel, such as an electric wheel in the form of a hub motor, whether using a multi-wheeled vehicle or The crawler type walking device can use the electric wheel as the main component of the walking device.

Two traction or drive motors (two hub motors) drive the left and right wheels, respectively (such as wheel 94 or wheels 9-2 or 9-3 or 9-1 or 94011, 94012),

When the bassinet or cradle bed or stroller turns, it can be driven at different speeds by electronic differential control.

The operation of the motor is connected to the switch on the armrest by the wire, and the user can issue a command, for example, the motor can be reversed by reversing the positive and negative poles, and the motor can be stopped by cutting off the power supply.

The maximum and minimum travel speeds of the bass or cradle bed can be fixed, the structure and shape of the wheel 9 and the material, as well as the way the wheel 9 and the bassinet or the cradle or the crib or the stroller are fixed. The universal casters of the supermarket trolley are exactly the same. The wheels of the wheels 94 and 9 can be screwed and fixed to the wheel frame by screws and nuts. The wheel frame is fixed to the wheel base in the same way, and the wheel base is the same. The method is fixed to the bottom of the vehicle body (reference numeral 3322), and other components can be fixed to the vehicle body in the same manner.

The working principle of the limit block (reference numeral 3409),

The limiting block of the present invention is detachable, and the wheel 94 is a universal wheel like the wheel 9 and the like. Only the wheel inside the crawler type walking device, such as the wheel 9-1 or 9-2, is not a universal wheel. Wheel 94 or 9-0, 9-4, 94011, 94012, is the wheel that carries the weight of the bassinet or cradle bed, the wheel 9 is exactly the same as the wheel of the supermarket shopping cart caster 9 from the structure to the function, in the wheel The inner side is equipped with a limit block (reference numeral 3409). The limit block can limit the left and right corners of the wheels 94, 94011, 94012, 9-0, 9-4, 94012, so that the user can control the bass or cradle bed. Direction of travel, working principle of brake shoes,

Brake shoes (reference numeral 501) can be installed on the upper part of the wheel. The working principle is the same as the common push-type switch (the principle can be the same as that of the push-type ball-point pen). The pedal of the user's foot brake shoe (reference numeral) 77667), causing the pedal to move downward, causing the brake shoe 9 (reference numeral 501) to protrude downward, and the friction block at the front end thereof is in close contact with the wheel 94 or 94011 or 94012, generating frictional force, thereby achieving wheel braking. When the user wants to start the vehicle, once again the pedal of the brake shoe, the pedal is reset, the brake shoe is retracted, the friction block leaves the wheel, and the wheel resumes rotation.

The working principle of the support foot,

The support leg (reference numeral 509) of the present invention is mounted on the body of the bassinet or the cradle bed (reference numeral 3322), and the structure and use of the support foot are common with the self-spring stay (ie Like the bicycle support foot, the structure is common knowledge. The electric motor of the present invention can be replaced by an internal combustion engine. After the replacement, the connection means of the traveling device, the operating device, the driving device, the transmission device and the like are similar to the known walking device of the automobile, the remaining components can still be based on human or electric manipulation.

The electric cradle bed or the bassinet or the stroller or the crib of the present invention uses a battery as an energy source, and the battery can be arranged on the cradle bed or the cradle or the bottom of the baby carriage or crib, or can be arranged on the cradle or the cradle bed or The rear of the stroller or crib is placed under the chassis. The selected battery should be able to provide high enough power, high-energy and high-powered power battery. The bass or cradle bed can be charged at any time with household power. The charging method is the same as the common electric bicycle charging method. Look like,

The bass or stroller or the lower part of the crib is equipped with an electric motor to drive the wheels to travel, thereby causing the cradle bed or the bassinet or the stroller or the crib to travel, said control switches being disposed on the armrests, said cradle With a cradle bed or a stroller or a crib, a wheeled walking device can be installed at the bottom, and the structure of the wheeled walking device is as described in the specification of the present invention, please refer to the following text.

3, the third technical solution, the crawler type detachable multi-functional cradle bed, the structure is as shown in FIG. 1, the technical scheme is basically the same as the technical scheme 1, and is only the big basket of the cradle in the middle of the technical scheme 1. After the side panel is put down, it becomes a bed board, and the handrail of the cradle of the technical scheme 1 (reference numeral 15) is shortened, for example, by using the spring ball on the armrest to engage with different positioning holes, the handrail is folded and shortened, into a cradle bed or a crib armrest, thus, the cradle of the technical solution 1 becomes the cradle bed described in claim 3, and if the cradle is disassembled, it becomes a crib, a cradle bed or a crib, the main technical features see technical solution 1,

The lower part of the cradle bed is equipped with an electric motor and a battery to push the bed to travel, and the control switch is disposed on the armrest, and the bottom of the cradle bed can be equipped with a semi-track type walking device, and the crawler type walking device structure See technical solution 1,

4, the fourth technical solution, the multi-wheel detachable multifunctional cradle bed, the structure thereof is shown in FIG. 3, the main technical features thereof are technical solutions 1, 2, and the technical scheme of the cradle according to the technical solution 2 The difference is that after the side panel of the big basket of the bassinet is put down, it becomes a bed board, and then the handrail of the cradle of the technical solution 2 (reference numeral 15) is folded and turned into a handrail of a cradle bed. The multi-wheeled bassinet of the technical solution 2 becomes the multi-wheeled cradle bed of the technical scheme 4,

The following is a brief description of the power device of the above-described cradle bed or bassinet, and the present invention has the following features.

1. All the cradle bed and the lower part of the cradle can be equipped with an electric motor. This motor can be disassembled. For example, after the motor is removed, the cradle bed and the cradle can be pushed and pulled by human power.

2, the above-mentioned cradle bed and cradle can be equipped with a shared device, the function and function of which are the same as the shared sharing system and sharing device of the known shared bicycle, the principle is the same, the cradle bed and the cradle and the stroller after the shared device is installed. With the crib, it is used in a similar way to sharing a bicycle. The way it is booked, the way it is picked, the way it is used, and the way it is returned is similar to that of a shared bicycle. It can make a cradle or a cradle as a shared bicycle, in different people. Used alternately and interchangeably,

3. All cradle beds and cradle cars can be equipped with real-time payment devices. The real-time payment device is a special type of smart phone with a camera on the outer side surface of the device, which is pre-installed with an instant payment system. One-click payment function, as long as the pay button is pressed, the payment interface will appear on the screen of the real-time payment device, and the user can click to select whether to pay for the initiative or passive payment. If the payment is made, the scan box will appear on the screen, and the user will only scan the box. Scan the payment with the merchant's payment code. If you click Passive payment, the payment code will appear on the screen. This payment code is the program installed by the phone inside its firmware or the third party program downloaded by the Internet (mobile app)), the merchant salesperson scans the payment code with the scanner to complete the collection task, and the device (smartphone) has a voice prompt for each step of the above operation.

4. All cradle beds and cradle cars and strollers and cribs can be equipped with air conditioning systems. The air conditioners refer to small or micro air conditioners.

5, all cradle beds and cradle cars can be inserted into the shared viewing utensils inside the card slot, the use of the method shown in FIG. 26 and later can not be,

6, all cradle beds and cradle and crib and stroller can be installed with a tablet.

7, all cradle beds and cradle cars, strollers and cribs can be equipped with electric fans.

8, all cradle and cradle and stroller and crib can be installed with limit block (reference numeral 3409) and brake shoes (reference numeral 501) and support feet (reference numeral 509) and non-slip Appliance (reference number 29),

Supporting feet, the working principle of the brake shoes, see the text in other parts of this manual,

9. All cradle beds and cradle can be fitted with an enclosure or sun shield (reference number 37).

10, all the cradle bed and the interior of the bass car can be installed with a rocker, this rocker (reference number 66 or 6666) can be removed,

11, all the cradle and the cradle and the stroller and the crib can be installed inside the battery, this battery can be disassembled,

12, all cradle beds and cradle and stroller and crib can be equipped with a conductive device (reference numeral 28) and a battery pack (reference numeral 30) and a large basket (reference numeral 24) The transmission device and the rocker and battery pack and the large basket are detachable.

13, all cradle and cradle and stroller and crib can be installed inside the adapter, player, voice control, switch, speaker, towing chair (reference number 77669), these parts can be removed,

14. The switch of the bassinet or the cradle bed is disposed on the armrest or the joystick,

15. The handrail or joystick of the bassinet and the bassinet or the stroller and the crib can be lowered and fixed to the rear of the cradle bed or the stroller or the crib or the cradle bed, or can be rotated to the upper part of the connecting ring. Fixed, many of the present invention are not seen, such as the connecting ring and the like can be hinged in a movable manner, the screw also includes a locking screw, and the components can be fastened with each other by a fastener, such as a side plate of a large basket. After the flat, the buckle on the side panel will be fastened to the ferrule on the vehicle body. When the buckle is released, the side panel will be reset for pushing the cradle bed. The manner of picking up and lowering is shown in FIG. 1, 3,

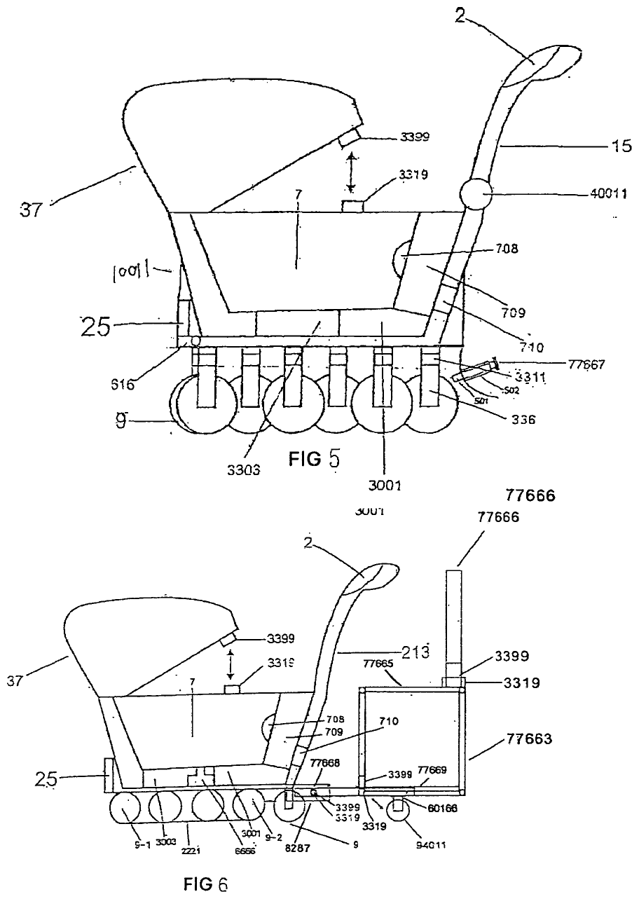

5, the fifth technical solution, the crawler type multifunctional bassinet, the structure thereof is shown in FIG. 6, and the technical scheme thereof is as follows.

At the bottom of the bassinet, an electric motor, a battery, a rocker, a push-pull chair (reference numeral 77669), a cradle inside the cradle, all of which can be disassembled, a towing chair, is a kind of person with wheels 94011. The movable towing chair is inserted into the slot of the towing chair under the chassis of the bassinet (reference numeral 77668), and when the towing chair is pushed, the spring card head (reference numeral 3399) on the towing chair pops up. The card slot of the dragging chair slot (reference numeral 3319) is used to lock the towing chair. When in use, the user presses the card holder of the towing chair to exit the card slot of the towing chair slot, thereby dragging the towing chair The ends of one end of the towing chair are provided with wheels 94011, one end is fixed with a spring (reference numeral 80018), and the other end of the spring is fixed inside the slot. When the chair is not towed, the towing chair is automatically reset, and the chair is to be used. At the time, after the towing chair is pulled out, the spring card or the positioning spring ball on the lower surface or the side of the towing chair will be automatically inserted into the inside of the card slot of the towing chair slot, thereby fixing the towing chair, when not in use, Using human power, push the towing chair, the ball or the card head to eject the slot of the slot under the action of external force, and the towing chair is pulled back by the spring. The reference number of the towing chair is 77669, and the reference number of the towing chair slot is 77668, the reference number of the chair of the towing chair is 3399, the reference number of the slot of the towing chair slot is 3319, the reference number of the towing chair spring is 800018, and the structure of the towing chair is shown in FIG., FIG. 25,

The front end of the bassinet or electric vehicle or cradle bed or crib of the present invention is provided with a horn, reference numeral 10011,

The following describes how the motor of the present invention drives the wheel, that is, how the motor drives the multi-wheel type traveling device. The technical solution of the present invention is as follows.

The bassinet or cradle bed or the crib or the stroller of the present invention can be driven by a motor-driven crawler type walking device or a motor, and a human-powered crawler crawler type cradle, 6, a sixth technical solution, a multi-wheel type The multifunctional cradle has the structure as shown in FIG. 5. The motor, the battery, the rocker, the cradle, and the towing chair are all disposed at the bottom of the cradle, and all of the cradle can be disassembled. The cradle can be driven by a motor. The device can also dismantle the electric motor, and adopts a manual push-pull multi-wheeled cradle. The cradle is provided with a sun hood, which is provided with a horn and a joystick and a control panel. The structural diagram of the towing chair is shown in FIG. 18, FIG. 6 and the drawing. 25,

7. The seventh technical solution, a human push-pull crawler type multifunctional cradle or a cradle bed or a stroller or a crib, the structure of which is the cradle or cradle bed of the above various technical solutions or the removal of the stroller or the crib motor For the battery and other related equipment, refer to the accompanying drawings 1-6. For example, the electric motor in the middle of the technical solution shown in FIG. 6 is used to remove the crawler type traveling device, and the technical solution described in FIG. 6 is immediately changed to the human power drive.

8, the eighth technical solution, the human push-pull wheel type multifunctional cradle bed, the structure is the cradle bed of the technical solution 4 to dismantle the motor and the battery and other related equipment, as shown in FIG. 5, the technology shown in FIG. The motor-driven multi-wheeled travel device of the solution is removed, and the technical solution is changed to a human power drive.

9. The ninth technical solution, the spring card slot air conditioner electric vehicle, the structure of which is shown in FIG. 16, the technical solution of which can install a micro air conditioner inside a seat of a known two-wheeled electric vehicle or a motorcycle. The battery is installed under the pedal, and its working principle is the same as that of the common electric vehicle. Only the air conditioner is installed under the seat, and the spring card slot and the sunshade are installed before and after.

10th technical solution, a card slot type shared viewing utensil, a shared appliance, but has the structure shown in FIG.

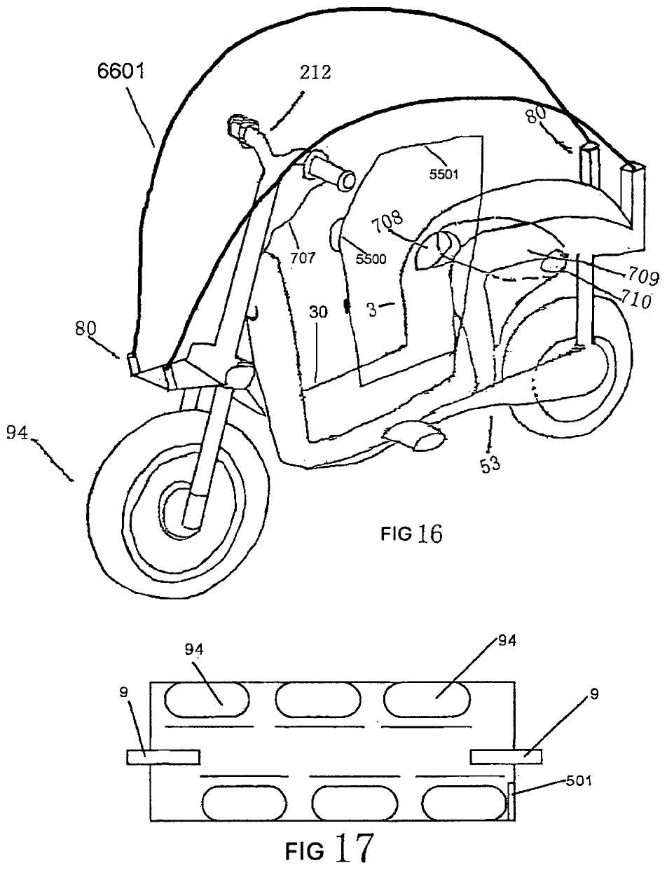

11. The first technical solution, a multi-wheeled traveling device used in the cradle bed and the cradle according to the present invention, the technical solution of which is as shown in FIG. 25, FIG. 17, FIG. 14, and FIG. Show,

A, the first technical solution, characterized in that

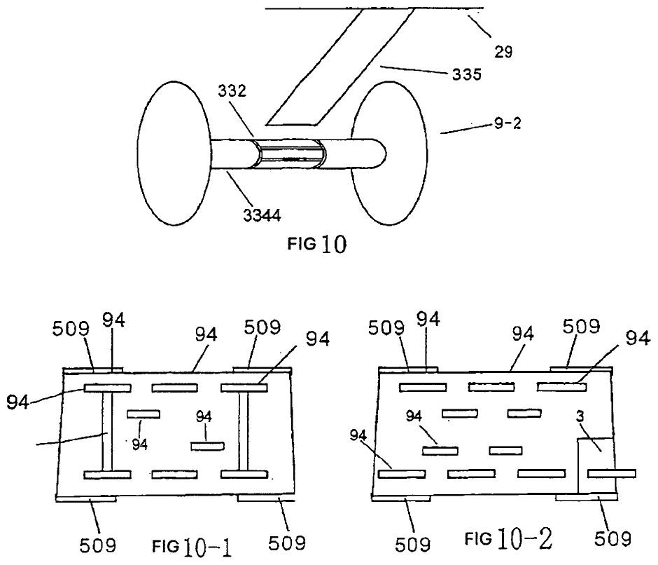

The first type of multi-wheeled walking device, the cradle or the bottom of the cradle has a row of wheels, the number is equal, the left side is 3, the right side is 3, symmetrically arranged, but there are two wheels in between, the installation of these two wheels The position and the left or right wheel are asymmetrically arranged, approximately less than one wheel radius, and the motor or internal combustion engine drives one or two sets of wheels on the left and right sides. The two or one set of wheels are the drive wheels, and the rest are driven wheels, as shown in FIG. 10-1,

B second technical solution, characterized in that

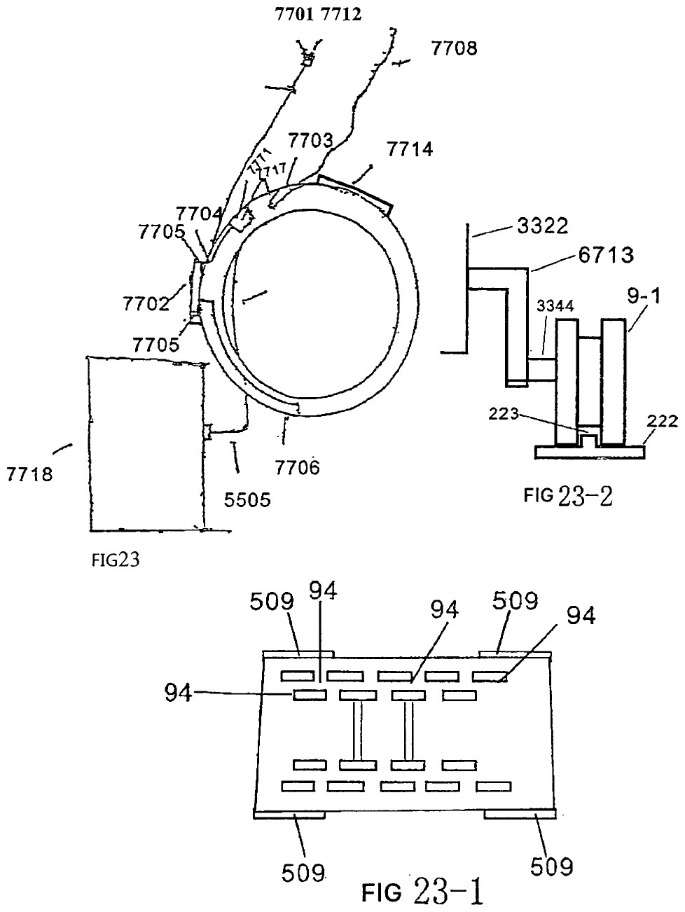

A multi-wheel type traveling device is characterized in that there are two rows of wheels arranged symmetrically in the left and right rows, and two train wheels are arranged in the middle of the two train wheels, and the two train wheels in the middle and the two train wheels on the outer side are installed in an asymmetric manner. One of the two middle train wheels is used as the driving wheel, the other wheel is used as the driving wheel, and the two pairs of wheels in the middle of the motor drive can be used as the driving wheel. The rest are used as the driven wheels. See FIG. 23-1.

18, the fourth technical solution, the left and right train wheels are symmetrically arranged, the positions of the left wheel are all symmetrical with the right wheel, but there are two train wheels in between, the installation position of the middle two train wheels and the left side The installation position of the two train wheels on the right side is asymmetrical, and the installation position of the two train wheels in the middle is smaller than the installation position of the left and right train wheels, see the radius of one wheel, see FIG. 23-1.

12. A twelfth technical solution, a real-time payment device, which is essentially a smart phone equipped with a pay-as-you-go system having a one-click payment function, see FIG.

13 The thirteenth technical solution is a luggage retractable bassinet, see FIG. 25,

The utility model relates to an xn cradle, which is composed of a luggage body and a retractable and folding joystick or armrest, a support rod, a wheel, an electric motor, a battery, a towing chair, etc., characterized in that the joystick is opened after the luggage On the side, the control panel is provided with a control panel, the bottom of the bag is provided with wheels, the inside of the bag is provided with a support bar, and the inside of the bag has a cradle that can be folded.

The bag is a basket car designed on the basis of a bag. The entire armrest or the joystick can be folded into the interior of the bag with the adapter ring as a shaft. The inside of the bag can be provided with a micro motor and a small battery and a micro air conditioner. The tail can be provided with a plug-in chair, as shown in FIG. 25 for a specific technical solution.

14. The fourteenth technical solution, a smart bracelet, is essentially a smart phone equipped with a pay-as-you-go system, which has a one-button payment function, see FIG. 15, FIG. 24,

The smart bracelet is a special type of smart phone whose camera is on the side of the outer casing, as shown in FIG. 15 and FIG. 24, which has a one-key payment function, as long as the pay button is pressed, the screen of the mobile phone is A payment interface will appear, the user can click to select whether to pay by default or passive payment. If the payment is made actively, a scan box will appear on the screen, and the user only needs to scan the payment box to check the payment code of the merchant, and if the payment is passive, A payment code will appear on the screen. This payment code is generated by the mobile phone installed in its firmware or by a third-party program (mobile app) downloaded from the Internet. The merchant salesperson can scan the payment code with the scanner to complete the receipt. Task, the above steps, the smartphone has voice prompts.

15th fifteenth technical solution, see FIG. 15,

A smart watch, which is essentially a smart phone equipped with an instant payment system, which can be inserted into a SIM card, which has a communication module, a processing module, a display screen, a voice module, a button module, a storage module, etc. Interconnected, similar to a smartphone or smart watch, the camera has a one-button payment function on the side of the side of the case.

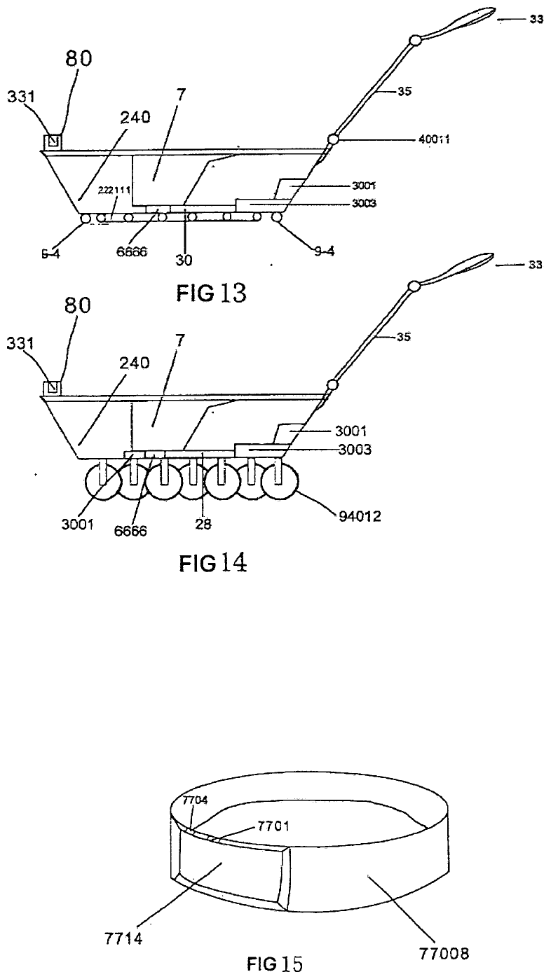

16. The sixteenth technical solution is that the electric cradle with the cradle and the air conditioner function is a technical solution of the present invention, and the bottom of the utility model can be equipped with a small crawler type walking device 222111 and a small wheel 9 (ie, Wheel 9-4), it is also possible to install a multi-wheeled traveling device (ie, the left and right train wheels are arranged asymmetrically, and the small wheels 9 are installed front and rear). The basket can be equipped with a miniature air conditioner and a battery and a rocker and an electric motor. The motor can be powered, the motor drives the wheel of the multi-wheeled traveling device, the battery can also supply power to the rocker, and the rocker can swing the cradle with power. The cradle of the present invention is labeled 7, the basket. The structure of the structure is shown in FIG. 13 of the accompanying drawings, FIG. 14,

The smart watch is a special smart phone with a one-click payment function. As long as the payment button is pressed, the payment screen will appear on the screen of the mobile phone, and the user can click to select whether to pay actively or passively. The scan box will appear on the screen. The user can scan the payment box to check the payment code of the merchant. If you click passive payment, the payment code will appear on the screen. This payment code is installed in the firmware of the mobile phone. Or it is generated by a third-party program (mobile phone app) downloaded from the Internet, and the merchant salesperson scans the payment code with a scanner to complete the collection task. Each of the above steps, the smart watch has a voice prompt.

Hereinafter, the structure of the electric drive device of the above-described cradle bed and cradle bed will be described as follows.

The technical solution of the motor-driven crawler type or multi-wheel type traveling device of the present invention may be a technical solution of a known motor-driven crawler type traveling device or a wheeled traveling device, and may also be the following technical solution.

The electric function of the bassinet or the cradle bed is to drive the axle to advance the wheel through the mechanical transmission of the main motor. The working principle is similar to that of the well-known electric vehicle. The secondary motor reciprocates back and forth by driving the transmission rod or the spring to suspend the suspension. The cradle suspension in the sleeve reciprocates in a straight line, and the swinger can also be installed at the bottom of the cradle. The swinger swings back and forth to make the cradle sway. The beneficial effect of the present invention is to make the general cradle multifunctional. It is convenient for the consumer, and the air conditioner can be installed on the cradle bed or the cradle, the cradle can be removed, or the cradle can be fixed, the swaying device can be installed to swing the cradle, or the swaying device can be turned off, so that the cradle does not come. swing.

Hereinafter, a brief description will be given of the structure of the above-described cradle bed and cradle bed wheel type traveling device,

The first type of multi-wheeled walking device has a train wheel at the bottom of the bassinet or cradle bed, the number is equal, three on the left and three on the right, arranged symmetrically, but there are two sets of wheels in between, and the two sets of wheels are installed. The position and the left or right wheel are arranged asymmetrically. There are one wheel 9 in front of and behind the two sets of wheels. The motor or internal combustion engine drives one or two sets of wheels on the left and right sides. The two or a group of wheels are active. The wheel, the rest is the driven wheel, and the limit block that can be raised and lowered can be set, as shown in FIG. 23-1.

2, the second technical solution, there are multiple wheels on the left and right, the number is equal, the installation position of each wheel on the right side is lower than the distance of the left side of the wheel, the front and rear of the two train wheels There is a pair of wheels 9, see FIG. 3, shown in FIG. 17,

19, the third technical solution, the number of left and right train wheels is equal, such as three wheels on each side, the installation position of each wheel on the right side is higher than the radius of one wheel of the installation position of the left wheel. There is one wheel 9 in front of and behind the two train wheels. Referring to FIG. 17, the multi-wheel type traveling device shown in FIG. 5 is such a structure, but the wheel 9 in the middle is not shown.

20, the fourth technical solution, the left and right train wheels are symmetrically arranged, the positions of the left wheel are all corresponding to the right wheel, but there are two train wheels in between, the installation position of the middle two train wheels and the left side The installation position of the two train wheels on the right side is asymmetrical. The installation position of the two train wheels in the middle is smaller than the installation position of the left and right train wheels. Referring to the drawings, one front and rear of the chassis are provided. Lifting wheel 9,

All of the wheels 9 of the present invention refer to the same structure and function as the universal casters of the well-known supermarket shopping cart. The wheels 9-0 refer to the small wheels 9, all of which can be convex on the supermarket's own ramp. The strips are engaged to prevent slipping, and all the wheels 9 are all mounted on the bassinet or the cradle bed in a manner that can be lifted and lowered, and the lifting and lowering can be controlled by hydraulic means, and the working mode of the hydraulic device according to the present invention The specific situation is as follows,

Hereinafter, the structure of the above-described cradle bed and cradle bed half-track type traveling device will be briefly described.

1, the first technical solution, see FIGS. 20 and 21 and 6, the essence is that the left and right two crawler type walking devices, in the middle of the two crawler type walking devices, a wheel 9 is arranged in front and rear,

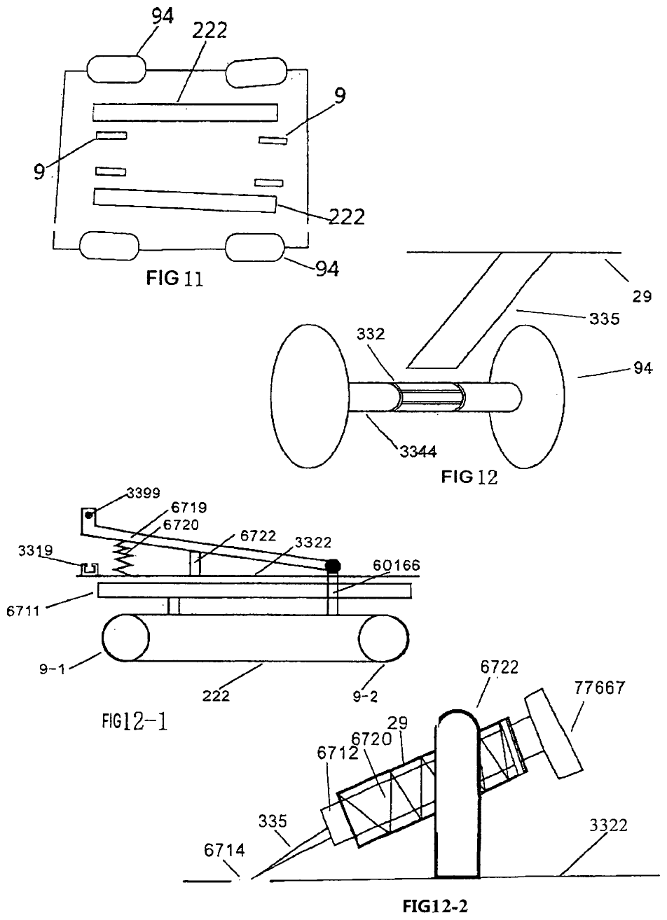

2, the second technical solution is, referring to FIG. 11, the essence is that there are two wheels on the left and right (reference numeral 94), there are two crawler type walking devices inside the wheel (reference numeral 222), and then inside There are four wheels 9, which are selected by the user to use the crawler type walking device or the wheel. Both the wheel 9 and the crawler type walking device can be lifted and lowered.

Hereinafter, a brief description will be given of the structure (reference numeral 29) of the anti-skid device of the above-described cradle bed and cradle bed,

The anti-skid device is disposed at the bottom of the bassinet or the cradle bed, and has a tab inside (reference numeral 335). The working principle is that when the user presses the switch on the armrest or the joystick, the anti-skid device is connected to the transmission device. The insert is then extended and the insert is inserted into the interior of the groove (reference numeral 332) of the axle (reference numeral 3344) to prevent the wheel from rolling.

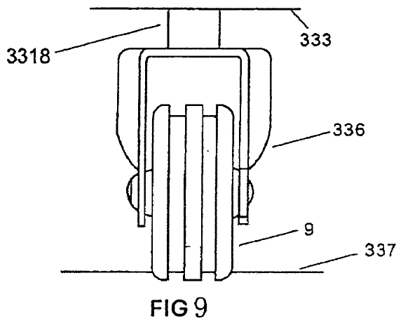

The bottom of the cradle bed and the cradle can be equipped with a supermarket shopping cart wheel, number 9, the structure of which is shown in FIG. 9, the bed of the wheel 9 and the cradle bed and the crib, and the wheel 9 and the cradle and the stroller. The connection of the car body is the same as that of the supermarket shopping cart wheel and the supermarket shopping cart body.

The wheel 9 may be a universal wheel such as a supermarket shopping cart wheel (supermarket shopping cart universal caster), such as a mounting limit block, or a wheel having a steering space of about 15 degrees on each side, as shown in FIG. Show,

The following is a description of the above-mentioned cradle bed or bassinet and crib and baby carriage switch device.

The switch is mounted inside the cradle bed and the cradle, and is mounted on the cradle bed and the arm of the cradle, as shown in FIGS. 1-6.

### BRIEF DESCRIPTION OF THE DRAWINGS

### Drawings

1 is a cross-sectional view showing a side structure of a body of a bassinet according to a first aspect of the present invention;

In the middle of FIG. 1, the various reference numerals have the following meanings.

3, for the motor and adapter, 1 for the coupling ring, 16 for the side bar, 13, for the speaker or buzzer, 7, for the cradle, 2 for the player and its switch, 15 for the armrest, 12 for the voice control (switch 5, active anti-mosquito sun protection canopy, 18 for the side bar, 3, for the motor and adapter, 17 for the chassis, 16 for the side bar, 10 for the speaker, 17 for the chassis, 6 for the small speaker, 14 for the movable sleeve, 17 is a side bar, a side bar, 7 is a cradle, 19 is a suspension bar suspended in the sleeve, 14 is a sleeve, and 18-1, 18-2, 18-3 are three sockets of the side bar, 17-1, 17-2, 17-3, 17-4 are four small bottom plates together to form the chassis, 4, spring or transmission rod, 3, electric motor, 7, cradle, 20 for positioning holes, 23 for screws 21 is the fourth side bar (pillar), 22 is the third side bar, 24 is the big basket, 25 is the small lamp, 10011 is the horn, 27 is the small fan, 26 is the small mosquito lamp, and 28 is the transmission device. 30 is a battery pack, the air conditioner is an air conditioner, 708 is a cold air outlet of the air conditioner, 710 is an external air outlet of the air conditioner, and the side rod is a pillar, and the brake shoe is marked 501.

2 is a schematic diagram of a bassinet or cradle bedside rod chassis according to the first to fourth technical solutions of the present invention,

The meaning of each mark is as follows.

The side bars 18-1, 18-2, and 18-3 are three socket segments of the side bars, and the four small bottom plates 17-1, 17-2, 17-3, and 17-4 together form a chassis, and the positioning holes are as shown in the drawing. Marked as 20, the screw is labeled 23

FIG. 3 is a schematic view showing the structure of the wheel type detachable multifunctional bassinet according to the second technical solution of the present invention, and the meanings of the respective symbols are as shown in the description of FIG. 1.

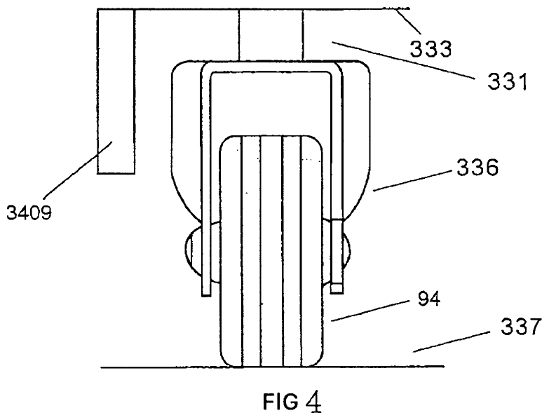

FIG. 4 is a schematic view showing the structure of the wheel 94 according to the second aspect of the present invention. The meanings of the respective symbols are as follows, 336 is a wheel frame, 333 is a wheel seat, 94 is a wheel, 3409 is a limit block, and 3311 is The spring is a spring column, and FIG. 5 is a schematic structural view of the multi-wheeled bassinet according to the present invention.

501 is the brake shoe, 77667 is the brake shoe pedal, 616 is the turning device of the wheel 9, 94 is the wheel, 80 is the spring card slot, 331 is the real-time payment device, 3399 is the sunshade, and 3319 is the card slot of the bass car. 709 is a micro air conditioner, 708 is an air outlet, 710 is an air outlet of an air conditioner, 15 is an armrest, and 2 is a control panel on the armrest, and all the reference signs 2 of the respective drawings are control panels, and control The panel has both a display screen and a control switch, reference numeral 501 is a brake shoe pedal, and 509 is a support foot.

FIG. 6 is a schematic structural view of a crawler type bassinet according to the present invention, and the meanings of the respective symbols are as follows.

The crawler track of the small crawler type walking device is 2221, the reference number of the miniature rocker is 6666, the reference number of the battery is 3001, the reference number of the micro motor is 3303, and the reference number of the towing chair is 77669. The reference number is 77668, 94011 is the wheel of the towing chair, which can be rotated and contracted on the chair slot.

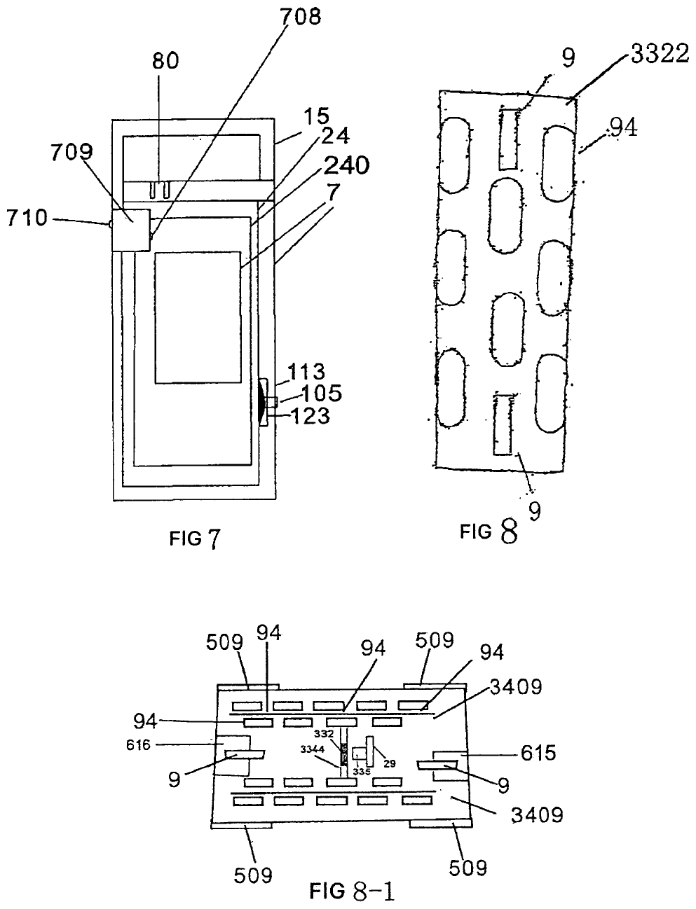

FIG. 7 is a top plan view of the bassinet or cradle bed of the present invention, the meaning of which is referred to in the specification.

FIG. 8 is a schematic structural view of a multi-wheel type traveling device according to the present invention, and the meanings of the reference numerals are as follows.

94 points to the wheel, 3322 points to the body of the bassinet, and 9 points to the wheel of the supermarket shopping cart.

8-1 is a schematic structural view of a multi-wheel type traveling device according to the present invention. The meanings of the reference numerals are referred to the specification, and FIG. 9 is a schematic structural view of the wheel 9 according to the present invention, 37 points to the automatic ramp, 3318 points to the connecting column, 333 points to the wheel base, and 336 points to the wheel shelf.

FIG. 10 is a structural view of the anti-skid device of the present invention, 29 pointing to the body of the anti-skid device, 3344 pointing to the axle, 9-2 pointing to the wheel of the crawler-type traveling device, 335 pointing to the insert, 332 pointing to the groove,

FIG. 10-1 is a schematic structural view of a multi-wheel type traveling device according to the present invention, and the meanings of the reference numerals are referred to in the specification.

FIG. 11 is a schematic view showing the structure of the chassis of the technical solution of the crawler type walking device and the wheeled traveling device of the present invention, the meanings of which are as follows, 222 points to the track, 9 points to the supermarket shopping cart wheel, and 94 points to the wheel of the wheeled traveling device,

FIG. 12 is a schematic view showing the structure of the anti-skid device according to the present invention in the middle of the technical solution of the multi-wheel type walking device. The meanings of the respective reference numerals are as follows.

FIG. 12-1 is a schematic structural view of a lifting device of a crawler type traveling device of a wheel-and-pile hybrid bassinet according to the present invention, and the meanings of the reference numerals refer to other characters of the patent specification of the present invention.

12-2 is a schematic structural view of the anti-skid device according to the present invention, the piston is 6712, the pedal of the piston is 77667, the anti-slip device is 29, the insert is 335, the large spring is 6720, and the cradle chassis has a gap of 6714.

FIG. 13 is a schematic structural view of the crawler type basket according to the present invention, the meanings of which are as follows, 222111 points to a small track, 3303 points to a miniature or small motor, 3001 points to a small battery, and 6666 points to a miniature rocker.

FIG. 14 is a structural view of the multi-wheeled tow basket according to the present invention, and the respective reference numerals have the following meanings.

94012 is the wheel, 9 is the supermarket shopping cart wheel, 6666 points to the miniature rocker, 3303 points to the micro motor, 3001 points to the small battery, 6666 points to the miniature rocker,

FIG. 15 is a schematic structural view of the smart wristband according to the present invention. The 7704 points to a one-click payment button, the 7701 points to a five-dimensional confirmation key, the 7714 points to the screen, and the 77008 points to a wristband.

FIG. 16 is a schematic structural view of a spring card slot electric vehicle according to the present invention, and the meanings of the reference numerals are as follows.

709 points to the air conditioner, 710 points to the external air outlet of the air conditioner, 708 points to the inner air outlet of the air conditioner, 5500 points to the door lock of the sunshade, 212 points to the electric vehicle handle, 2094 points to the electric vehicle wheel, and 707 points to the conductive line. 30 points to the battery, 3 points to the motor, 6601 points to the transparent sunshade, 5501 points to the transparent plastic door, 80 points to the card slot, 53 points to the drive shaft, and FIG. 17 is asymmetrical according to the second technical solution of the present invention. Schematic diagram of the chassis structure of the arranged multi-wheeled traveling device,

616 points to the turning device of the wheel 9, 3209 points to the limit block, 94 points to the wheel, 9 points to the supermarket shopping cart wheel, 77667 points to the brake shoe pedal, and 501 points to the brake shoe.

FIG. 18 is a schematic view showing the structure of the chair of the present invention, and the meaning of each mark is referred to in the present specification.

FIG. 19 is a schematic view showing the charging structure of the turning device of the wheel 9 according to the present invention, and the meanings of the reference numerals are as follows.

211211 points to a rotatable bolt (screw), 616 points to the support block, 2312 points to the positioning hole, 2412 points to the head of the cassette, 60166 points to the screw, 333 points to the wheel base, 3318 points to the connecting post, and 9 points to the supermarket shopping cart wheel.

FIG. 20 is a schematic view showing the structure of the crawler type traveling device of the present invention, and the meanings of the respective reference numerals are referred to in the present specification.

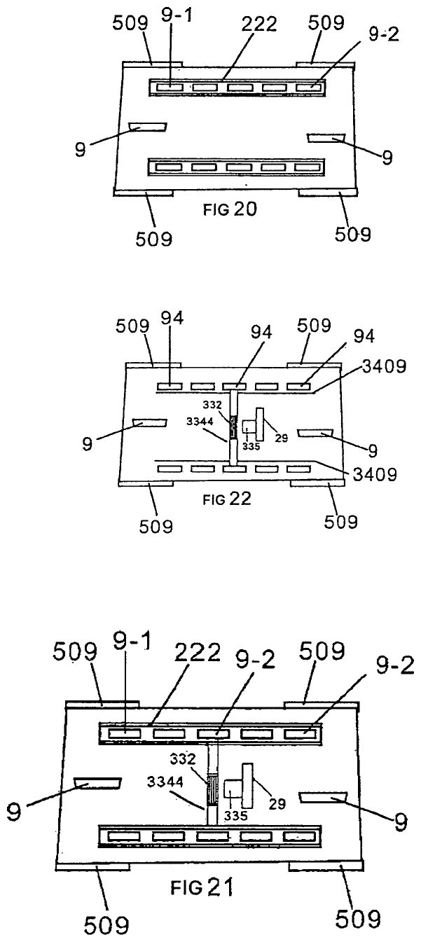

FIG. 21 is a schematic view showing the structure of the crawler type traveling device of the present invention, and the meanings of the respective reference numerals are referred to in the present specification.

FIG. 22 is a chassis diagram of a symmetrically arranged multi-wheel type traveling device of the present invention, the meaning of each reference numeral is referred to in the present specification.

FIG. 23 is a schematic structural view of the smart wristband of the present invention, and the meanings of the respective reference numerals are as follows

In the middle of FIG. 23,

7705 refers to the red light or laser transmitter, 7702 is the scanner or camera of the smart watch, 7704 refers to the voice broadcaster, 7707 points to the wireless networking device and the circuit board and circuit board and battery, 7716 is the switch line, 7701 and 7712 are confirmation buttons, 7701 is a one-click payment button, 7714 is a smart watch screen, 7706 is a folding screen storage compartment, 7718 is a roll-up screen or a folding screen, 7708 is an external antenna, 77008 is Smart hand replacement wristband,

FIG. 23-1 is a schematic structural view of a walking device according to the present invention, and the meanings of the various reference numerals are referred to in the specification.

FIG. 24 is a schematic structural view of a smart watch real-time payment device (a real-time payment smart phone) according to the present invention;

FIG. 24 is a drawing of the specification of the present invention, and FIG. 18 is a structural view of a smart watch equipped with a supermarket shopping instant settlement and real-time payment system according to the present invention. In the middle of FIG. 24, the meanings of the reference numerals are as follows,

8803 refers to the one-button payment button, 8804 is the scanner or camera of the smart watch, 8809 refers to the voice broadcaster, 88111 is the switch line storage compartment, and 8808 points to the wireless networking device and the circuit board and the circuit board and the battery. 8821 is the switch line, 8818 is the confirmation button, 8814 is the screen of the smart watch, 8807 is the folding compartment of the screen, 8801 is the roll-up screen or the folding screen, and 8805 is the external antenna.

FIG. 24-1 (formerly FIG. 36) is a schematic structural view of the positioning head and the fixing-head of the revolving device of the present invention, and the meanings of the reference numerals are as follows.

2412 is the positioning head, 23017 is the tail end of the positioning head, 2312 points to the positioning hole, 23012 points to the fixed head, 23016 points to the fixed head pull switch, 23015 points to the notch of the positioning head, 23013 points to the spring, and 23014 points to the fixed seat of the fixed head.

FIG. 24-2 is a schematic structural view of the wheel 94001 according to the present invention. For the meaning of the mark, refer to other parts of the specification.

FIG. 25 is a schematic structural view of the xs bassinet according to the present invention. The 2 is directed to the control panel. The 9801 points to the lock, the 555 points to the support bar, the 3737 points to the upper half of the case, and the 21003 points to the steel ring (the lower half of the case) Partially) 10011 points to the horn, 25 points to the small light, 7 points to the detachable cradle 4001 adapter ring, 708 is the air outlet of the air conditioner, 710 is the air outlet of the air conditioner, 15 points to the handrail, and 616 points to the lift of the wheel 9. The device, 3303 points to the micromotor, 3001 points to the small battery, 336 points to the wheel shelf of the wheel 94, 94 points to the wheel, 3399 points to the cassette, 339 points to the slot 60166 to point to the screw, 94011 points to the wheel, 77668 points to the tow chair slot, 77669 points Tow chair, 21001 points to the zipper, 21002 points to the zipper head, 21003 points to the rim of the bag, 213 points to the joystick, 2 points to the control panel, 77666 points to the back of the chair (can be folded) 77665 points to the seat, the wheel labeled 94011 It can be folded and raised. In the middle of the present invention, the wheel pointed by the reference numerals 94011, 94, 94001, 94012 can be a universal wheel.

FIG. 26 is a schematic structural view of a shared viewing device, the meanings of which are as follows,

A multifunctional shared viewing utensil, consisting of a base (reference numeral 11), a cassette (reference numeral 7), a cylinder (reference numeral 2), a chip of mp3, and a circuit board (reference numeral 1), flower (reference numeral 4), battery, spray or atomizing device (reference numeral 6), mp3 control button (reference numeral 8), main switch, spotlight (reference numeral 14), an elastic band (reference numeral 15), a buzzer (reference numeral 12), a flower mud tank (reference numeral 16), a mp3 horn fixed to the surface of the cylinder (reference numeral 2) or Mp3 screen (10), hook (13), camera or recording microphone, card slot (reference numeral 19), handle (reference numeral 5), data line, ribbon transmitter (reference numeral 3), Mp3 data interface (reference number is 17),

The utility model is characterized in that: a cassette (reference numeral 7) is below the base (11), and a horn of the mp3 is installed outside or inside the cylinder (reference numeral 2), and the flower is inserted in the flower mud of the flower mud tank. Mp3's data interface (17) on the surface of the base,

The camera or recording microphone is on the surface of the base (reference numeral 11), and the mp3 chip and the circuit board (1) are inside the base (reference numeral 11).

Wherein, the spray or atomization device (6) is on the bottom sides of the inside of the cylinder (reference numeral 2), the card slot (19) is on the surface of the base (reference numeral 11), and the base (reference numeral is 11) Below the cylinder (2), the flower (4) is inside the cylinder (reference numeral 2), the spotlight (reference numeral 14) is at the bottom of the cylinder (2), and the elastic band (Fig. The mark is 15) on the outside of the cylinder (2), the flower mud tank (16) is at the bottom of the cylinder (2),

The handle (5) is on the outside of the cylinder (2), the control button (8) of the mp3 is on the outer surface of the cylinder (2), and the screen of the mp3 (reference numeral is 10) is in the cylinder (reference numeral is 2) On the outside, the main switch is on the surface of the base (reference numeral 11), the hook (reference numeral 13) is on the outside of the base (11), the buzzer (12) is inside the base (11), and the data line (22) Between the mp3 chip and circuit board (1) and the mp3 speaker or screen (reference numeral 10), the ribbon transmitter (reference numeral 3) is on the inside of the cylinder (reference numeral 2) At the bottom, the mp3 refers to an mp3 device with a recording and recording function and a playback and playback function. The user inserts the viewing device into the spring card slot. As shown in FIG. 3, the baby inside the bass car can see the scent of the flower, and the shared viewing device has the same sharing system as the shared bicycle, and the user can In order to book, pay, use and return by mobile phone, the shared viewing device is denoted by reference numeral 30011 in the middle of FIG. 3, the shared switch and control system has the reference numeral 9003, and the automatic locking device is 9002. Mark 9001 points to the hole,

10-1 is a schematic structural view of a lever lifting device of a crawler type traveling device of a wheel shared common bassinet or a crib or a cradle bed or a stroller,

FIG. 28 is a schematic structural view of a multi-wheel type traveling device according to the present invention, and the reference numerals are referred to the present specification.

FIG. 23-2 is a schematic structural view of a wheel 9-1 of the crawler type traveling device according to the present invention, Mark 9-1 points to the load wheel that is placed inside the track, 223 points to the convex tooth in the middle of the track shoe, 222 points to the track, 3344 points to the axle, and 6713 points to the connecting part (the connecting part between the axle and the car body) 6718 points to the spring column (or shock absorbing spring)

The support bar of the luggage bassinet protrudes upward from the bottom, the top end of which supports the inner top of the upper half of the bag, and the lower part is arranged at the bottom of the bag, and the inside of the bag has three fixing buckles (reference numeral 9801) for fixing the support frame.

A multi-wheel type traveling device, wherein the left and right rows of wheels are asymmetrically arranged, and the middle two rows of wheels are also asymmetrically arranged, and each wheel is independently connected to the output shaft of the transmission driven by the internal combustion engine or the motor, and the wheel thereof It is connected to the chassis of the vehicle body by a spring damping column or a damping spring, see FIG. 10-1.

The folding screen or the roll-up screen of the present invention may refer to a flexible screen, such as an OLED screen, all of which are touch screens, and the customer user can directly touch and click the screen with a finger to operate the watch and the bracelet.

The folding screen or the scrolling screen referred to in the present invention are all touch screens.

In the middle of FIG. 23 and FIG. 24, the drawing of the folding screen, the scrolling screen, the data and the power transmission line between the screen of the smart bracelet or the smart watch is marked 5505, j.

Hereinafter, the technical features and the meanings of the respective marks will be described with reference to the accompanying drawings.

The technical characteristics of the multifunctional bassinet according to the first technical solution shown in FIG. 1 are as follows.

Handrail {connected to the body side bar 16 by the coupling ring 1} The speaker or buzzer 13 is placed on the cradle 7 frame, the player and its switch and its display screen and its controller (reference numeral 2) are on the armrest (Marked as 15), the active anti-mosquito sun protection canopy (labeled 5) is connected to the body side bar 18 with a coupling ring (labeled 1), the motor (labeled 3) and the adapter (labeled 3) are placed on the chassis (marked) For 17), the voice control (switch) (marked 12) is above the body side bar (labeled 16), the speaker (labeled 10) is on the chassis (labeled 17 and the small speaker 6 is on the second side 16) And under the side bar (labeled 18), the movable sleeve (labeled 14) is fixed to the side bar 16 and the side bar 22 and the first side bar 18 and the side bar 21, and the cradle (labeled 7) is suspended by the suspension bar 19. In the sleeve 14, the side bars are 18-1, 18-2, and 18-3 are three socket segments of the side bars, and four small bottom plates (labeled 17-1, 17-2, 17-3, 17)-4) Together form the chassis, the drive rod or spring (labeled 4) is connected to the motor (marked 3) and the cradle (labeled 7), plus a locating hole (labeled 20), screw (labeled 23), fourth Side bar (pillar) 21, third side bar (22), large basket (labeled 24) Small light (labeled 25), small fan (marked 27), small mosquito lamp (26), conduction device (labeled 28) and battery pack (labeled 30) in the lower part of the large basket, the side bar is the pillar As shown in the multi-function bassinet, the armrest (connected to the sidebar (marked 16) by the coupling ring 1) the speaker or buzzer (labeled 13) is placed on the cradle (labeled 7) border. The player and its switch and its display screen and its controller 2 are in the armrest 15, and the movable anti-mosquito sun protection canopy 5 is connected to the vehicle body side bar 18 by the coupling ring 1, and the motor and the adapter 3 are placed on the chassis 17 for sound control (switch 12 is above the body side bar 16, the speaker 10 is on the chassis 17, the small speaker 6 is below the second side bar 16 and the side bar 18, and the movable sleeve 14 is fixed to the side bar 16 and the side bar 22 and the first side In the rod 18 and the side rod 21, the cradle 7 is suspended in the sleeve 14 by the suspension rod 19, and the side rods 18-1, 18-2, 18-3 are three socket sections of the side rods, and four small bottom plates 17-1, 17-2, 17-3, 17-4 together form the chassis, the transmission rod or spring 4 is connected to the motor 3 and the cradle 7, and the positioning hole is denoted by 20, and the screw is labeled 23 fourth side rod (Pillar) 21, third side The rod 22, the large basket 24, the small lamp 25, the small electric fan 27, the small mosquito killer lamp 26, the anti-skid device 29, the conducting device 28 and the battery pack 30 are in the lower part of the large basket, and the side bars are the pillars.

1 and 8 of the present invention are schematic views of the structure when the vehicle body is drawn into a full length, which can be shortened as needed in actual use. The large basket and the cradle and the basket can be used independently of the cradle, and can be disassembled by itself. Change the size, install (can be painted or attached) reflective ribbon on both sides of the car body to warn the vehicle, mark 222 refers to the track, reference numeral 66 points to the rocker, reference numeral 240 points to The tow basket, said the supermarket push cart has a wheel base mounted on the bottom of the shopping cart, the wheel base is screwed to the screw hole in the bottom of the cradle bed or the cradle, and the wheel frame of the supermarket shopping cart wheel (that is, the wheel 9) The upper end, labeled 3318), is rotated and fixed to the wheel base, the lower end of which is connected to the wheel (rotatable), 37 is directed to the sun shield, 25 is directed to the small light, and 41 is directed to the support frame, 15 Pointing to the armrest, 66 points to the rocker.

In the middle of FIG. 1, the various reference numerals have the following meanings.

3, for the motor and adapter, the invention is abbreviated as the reference numeral 3 or 3303 motor and small motor,

4, in the middle of the reference mark,

1 is the coupling ring, 16 is the side bar, 13 is the speaker or buzzer, 7, is the cradle, 2 is the player and its switch, 15 is the armrest, 12 is the voice control (switch), 5 is the active mosquito Sun protection canopy, 18 for the side bar, 3 for the motor and adapter, 17 for the chassis, 16 for the side bar, 10 for the speaker, 17 for the chassis, 6 for the small speaker, 14 for the movable sleeve, 17 for the side bar, side bar 7, is the cradle, 19 is the suspension rod suspended in the sleeve, 14 is the sleeve, 18-1, 18-2, 18-3 are the three sockets of the side rod, 17-1, 17-2, 17-3, 17-4 for the four small bottom plates to form the chassis together, 4, for the spring or transmission rod, 3, for the motor, 7, for the cradle, 20 for the positioning hole, 23 for the screw, 21 for the fourth side (pillar), 22 is the third side bar, 24 is the big basket, 25 is the small lamp, 27 is the small fan, 26 is the small mosquito lamp, 28 is the conduction device, 30 is the battery pack, and the air conditioner is marked 709 708 is the air supply port of the air conditioner for cold air or hot air, 710 is the air outlet of the air conditioner, and the side pole is the pillar.

As shown in the multi-function bassinet, the armrest (connected to the sidebar 16 by the coupling ring 1) the speaker or buzzer 13 is placed on the cradle 7 frame, the player and its switch and its display screen and its control device 2 In the armrest 15, the movable mosquito-proof sunscreen canopy 5 (awning) is connected to the vehicle body side bar 18 by the coupling ring 1, the motor and the adapter 3 are placed on the chassis 17, and the voice control (switch) 12 is om the body side bar 16 Above, the speaker 10 is on the chassis 17, the small speaker 6 is below the second side bar 16 and the side bar 18, and the movable sleeve 14 is fixed to the side bar 16 and the side bar 22, and the first side bar 18 and the side bar 21, the cradle 7 is suspended in the sleeve 14 by the suspension rod 19, and the side bars 18-1, 18-2, 18-3 are three socket sections of the side bars, and the four small bottom plates 17-1, 17-2, 17-3 17-4 together form a chassis, the transmission rod or spring 4 is coupled to the motor 3 and the cradle 7, and the positioning hole 20 is screwed to the fourth side rod (pillar) 21, the third side rod 22, the large basket 24, the small lamp 25, The small electric fan 27, the small mosquito killer lamp 26, the anti-skid device 29, the conducting device 28 and the battery pack 30 are in the lower part of the large basket, and the side bars are the pillars.

In the middle of each figure, the meanings of the reference numerals are as follows, 9 is the supermarket shopping cart wheel, 9-1 and 9-2 are the wheels of the crawler type walking device, 9-3 is the ordinary cradle wheel, and 94 is grooved. Hand-pushing the rickshaw wheel, 9-0 is the same structure as the supermarket shopping cart wheel, but it is much smaller than the supermarket shopping cart wheel, this wheel can be installed at the bottom of the big basket, so that the big basket can be fixed in the supermarket There is no slip on the escalator. The 9-4 is the same size as the supermarket shopping cart wheel, but the much smaller wheel is installed at the bottom of the basket or cradle so that the basket and cradle can be fixed. On the escalator in the supermarket, there will be no slipping, 41 is the sunshade support frame, and 88 is the sunshade support frame base.

30011 points to the shared viewing device, 40011 points to the adapter ring

The cradle bed and the cradle can be equipped with a wireless payment device, the reference numeral is 331, and the usage mode is referred to other parts of the specification.

2 is a structural diagram of a cradle bed and a bassinet floor chassis in the middle of the present invention. In the middle of FIG. 2, 17-1, 17-2, 17-3, and 17-4 are four small bottom plates, and 20 is a positioning hole. 23 is a screw, and the side bar is the pillar.

In the middle of each figure, 37 points to the sunshade, 33, to the pull ring of the drag basket, 240 points to the drag basket.

Inside this spring card slot, you can get stuck in a smart watch or smartphone or a regular smartphone or a tablet with a real-time payment system, as a user who can make a cradle or a cradle or a cradle can shop at the supermarket. At that time, the function of paying for the purchased goods (ie, instant scanning, instant payment) is realized, and 80 is a spring card slot.

The wheel 9 (that is, the supermarket shopping cart wheel) is a drawing of the specification of the present invention.

In the middle of each embodiment, the spring card slot can be mounted with a sun hood, and the sun hood can be connected as a cover between the spring card slots, and the two sides of the cover can be covered to cover the cradle and the cradle bed of the present invention. Shopping cart, the entire body of an electric car,

In the middle of the drawings, reference numeral 55 is a seat, 281 is a robot with a telescopic support frame, 31 is a steering wheel, and 80 is a spring card slot. In the middle of each drawing, 240 points to the basket, and 708 points to the air conditioner. The air vent of the air conditioner is the hot air inside (the hot air in the winter when heating) or the cold air (the cold air in the summer)

In the middle of each technical solution, 94001 points to a bassinet or cradle bed wheel with a groove of the same size as the wheel 9 of the same wheel. The bottom of the cradle bed can be equipped with a supporting foot, which is movable and can be retracted. The raising or lowering can be controlled by the user through the switch on the armrest, or can be controlled by manpower.

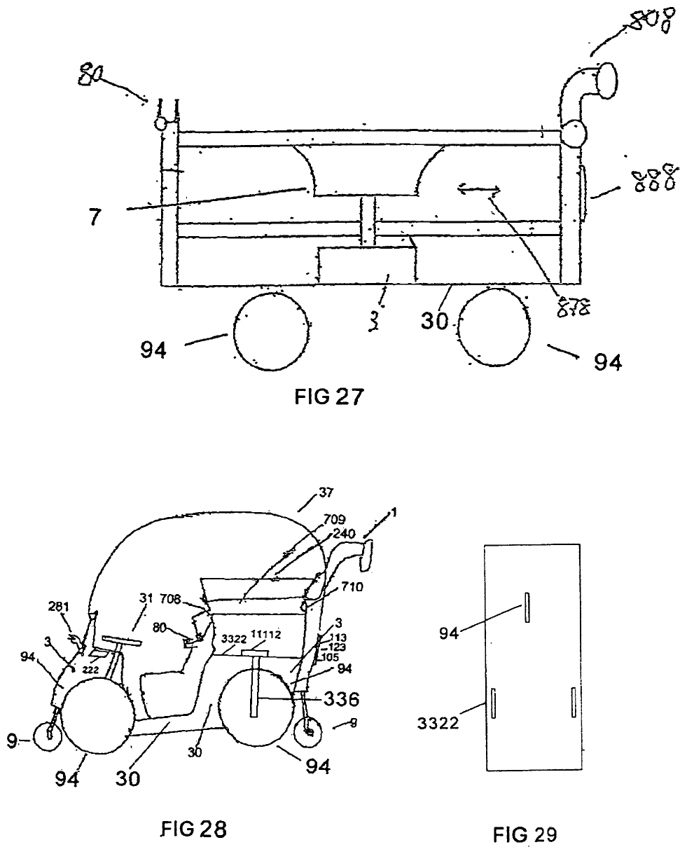

Reference numerals such as 94,94011,94012,94001 are known as pram wheels, and 9-4 points to the same structure as the supermarket shopping cart wheel structure for the bottom of the basket, and 9-0 points to The bottom of the big basket is the same as the supermarket shopping cart wheel structure. It can prevent the wheels from slipping on the escalator. The 9-4, 9-0 wheels are the same structure as the well-known supermarket shopping cart wheels (that is, the wheels 9). See the drawing, but its size, that is, the size, is only about one-third to one-fifth of the wheels of an ordinary supermarket shopping cart. The 94011 refers to the wheel of the agent's walking device at the bottom of the big basket, and the 94012 refers to the basket. The wheel of the agent traveling device at the bottom, 94001 refers to the function of the wheel 94, the same size as the wheel 94, but the wheel surface has the groove and the rib of the wheel 9 which can be used again. The automatic ramp is as non-slip as the wheel 9. Referring to FIG. 26, the compromised wheel can also be mounted with the bottom of the bassinet and crib of the present invention. FIG. 27 is a schematic view of the shared air freshening device. The new device is designed to help the baby inside the sunshade to breathe the fresh air to adjust the air. It can be snapped into the spring card slot. It is a part of the bassinet, the cradle bed, and the stroller. It is a new type of air. Adjustment device

The meaning of the reference numerals is as follows.

261 is a small mosquito killer with a spring card slot function. The spring card slot in the middle of the device, the side plate of the large basket can be put down, and the two side panels of the large basket can be locked, so that The big basket becomes a bed (in the reference numeral of the present invention, 1001 is the bed), the bassinet becomes a cradle bed, and the original figure, the cradle of 1, 3 becomes a cradle bed, which is a cradle bed with a half-track or multi-wheel type walking device, characterized in that there is a movable bed board, a cradle on the bed board, and a hollow hole in the bed board, which can be used for an electric motor or a rocking device The transmission device passes through the bed plate and is connected with the cradle. The cradle is shaken by the connecting device, and the cradle can be disassembled. The cavity can be closed, so that the bed plate becomes a whole, the cradle is removed, and the baby can be slumbered in the middle of the bed plate, so the cradle bed It becomes a crib with a walking device, and a sunshield is attached to the outside to cover the crib. Since the spring card slot is installed, the spring card slot is stuck. There is a smartphone or tablet for real-time shopping and real-time payment system (real-time payment system), so the baby crib can hold the mobile phone or wirelessly pay in real time because of the spring card slot and other corresponding devices. The device (which is a real-time payment system according to the present invention, which is similar in function to the mobile phone) has a payment function, and all the spring card slots of the present invention are screwed to the cradle of each cradle bed or electric vehicle or cradle surface. Inside the hole,

or other methods are installed on the surface of each car body or bed,

Inside the various technical solutions, the wheel 9, the wheel 9-0, and the wheel 9-4 are all connected to the body or the bottom of the cradle bed or its mounting bracket in a rotatable manner, and the connection of the wheel 9 to the body or the cradle bed The method refers to the connection method of the supermarket shopping cart wheel and the supermarket shopping cart body. The wheel 9 is generally not connected by a spring column. In the various technical solutions, the wheels other than the wheels 9, 9-0, 9-4 can be used. A spring post or spring acts as a tool for connecting to a wheel base or mechanical transmission at the bottom of the body.

Within each technical solution, 3 points to the motor, 30 points to the battery (battery pack), 9 points to the supermarket shopping cart wheel, and 222 points to the cradle bed or cradle crawler type walking device, 709 The micro air conditioner is pointed at. The air conditioner has various installation methods. The installation on the bassinet and the cradle bed is all like this. The installation position is above the battery pack at the rear of the vehicle body, and the cold air outlet is facing the interior of the vehicle body. The exhaust vent is facing the outside of the car body, 37 as a sun visor, which can cover the entire car body and the cart person, or just cover the inside of the car body. Similarly, the electric car can also follow the air outlet (attached The figure is labeled 708) facing the front (toward the inside of the enclosure), and the air outlet (reference numeral 710) is installed rearward (toward the outside of the enclosure) to install the air conditioner.

Combined with the drawings

### DETAILED DESCRIPTION OF THE INVENTION

### Detailed Ways

The present invention can be implemented by the following technical solutions.

As shown in FIG. 1, the embodiment 1 is known to produce the technology, equipment and materials of the electric crawler type vehicle, and the built-in player and the speaker 6 are in the vehicle body during the production process, and the player and the display screen and the switch controller are externally Placed in the grab bar 15, when the user wants to switch the player, press the button, the player data interface is also here, convenient for the user to change the content, the player is connected to the speaker 6 through the built-in audio output line, thereby realizing the sound output At the same time, the voice control switch 12 can also control the switch of the player. When receiving the external strong sound source, the music is turned on and the main and auxiliary motors 3 are in the middle of the chassis of the vehicle body. After the start, the main motor moves back and forth through the drive transmission rod 4 or The spring 4 moves back and forth to drive the cradle 7 that is fixed to the transmission rod 4 or the spring 4 [suspended in the sleeve 14 by the suspension rod 19]. The cradle 7 reciprocates linearly back and forth, and the secondary motor drives the wheel through the mechanical transmission. And the coupling ring 1 between the armrest and the car body and the anti-mosquito sun protection canopy 5 and the vehicle body can lock the armrest 15 and the car body and the anti-mosquito sun protection canopy 5 and the vehicle body at multiple angles, the wheel and the vehicle The body connection part can be the same

Designed, the wheels can be locked in a variety of ways in a variety of ways, including

First, the wheel (9) is a supermarket shopping cart wheel with a non-slip design. The connection method between the wheel (9) and the bassinet or cradle bed adopts the design scheme of the well-known supermarket shopping cart wheel (for example, the wheel is designed to prevent it from being The technology of moving on the ramp escalator in the supermarket), the way of connecting the wheel 9 with the cradle bed or the cradle is the same as the way the supermarket shopping cart body is connected with its wheel. Second, the design of the wheel also includes other known wheel locking technologies. It can prevent wheel movement, wheel (9) design and wheel (9) and car body connection design is the same as supermarket shopping cart, wheel (9-1) and (9-2) design and wheel and car body connection design and Known (tank or crawler armored vehicles or civilian or toy or children) vehicles are the same, wheels (9-1) and (9-2) can be used to set the wheels inside the crawler type walking device, said bass car Or the cradle bed can be used as a cradle when not driving, and because the side rod of the vehicle body adopts a segmented sleeve design, it can also adopt a design such as a tie rod type or a fixed screw hole positioning rod, and the side rods are actually mutual Through the screw holes, each The lower part of the block side rod is nested with the upper part of the next side rod, and the two side rods that are connected between each other are screwed by the adjusting holes to fix the overlapping portions of the overlapping portions of the side rods by screws Fixed, the chassis is divided into four pieces, and the bottom plate partially overlaps each other. When the two bottom plates are moved to a predetermined position, the screw positioning holes 20 of the two plates are overlapped, and the fixing screws 23 are screwed and fixed, and the height and length are fixed. The screw 23 can be adjusted by screwing, and the screw 23 is screwed or unscrewed at different position positioning holes 20 at the side bars 18 and the chassis 17, etc., thereby achieving the purpose of making the vehicle body larger and smaller, and as an improvement, The user can use the common simple tools on the market according to the instruction manual, such as a screwdriver (no need for additional equipment), and change the length and width of the car body and the size of the cradle body as needed. The cradle is like a main motor 3, and is reduced. The size of the car body allows the user to make room for the car body to be reduced to a small walker, such as (the big basket after the cradle is removed and fixed on the four side bars) The body size is elongated and widened, then Children become bedstead, such as the vehicle pulled up, it can become a storage closet. The anti-mosquito sun protection canopy 5 and the cradle 7 can be removed and washed, and the playback content can be changed at any time through the player data interface. The voice control (switch) 12 is an optional function. When the user is in the cart, the small lamp 25 can be used. Road, the snacks and diaper boxes not shown in the figure can be hung beside the cradle, the conduction device 28 and the battery pack 30 are in the lower part of the large basket, and the large basket 24 can be loaded with debris, and the small electric fan 27 and the small mosquito killer can be activated. 26 mosquito repellent, in order to prevent the child from feeling uncomfortable, the cradle 7 is made of foldable or telescopic material or telescopic structure (such as one end can be fixed to the side of the car, the other end can be opened, hanging on the hook in the car body to form a cradle It can be restored when not in use. The inner pad and the pillow (not shown) can be placed in a flat shape after moving the cradle to one side, or can be placed in the free space next to the cradle of the child. In order to be used as a shopping cart, the motor can be divided into a main motor driven wheel and a secondary motor to reciprocate the electric cradle. As an improvement, the walking device of the multifunctional cradle can be selected by the user (optionally without electric drive), and the user can control the armrest. Switch, The number of wheels can be increased or decreased, and the user can select his mode of operation so that the motor drives the wheels to advance at a low speed and the switch is placed in the armrest.

As shown in the figure, in the third embodiment, the technology, equipment and materials for producing the electric cradle and the cradle bed and the production of the electric crawler type vehicle are known, and the crawler type walking device and the cradle bed are combined with each other in the production process, and the cradle bed armrest is built-in and played. The player 2 and the speaker 6 are in the vehicle body, and the player and the display screen 2 and the switch controller 2 are externally placed in the handrail bar 15. When the user wants to switch the player 2, the button is pressed, and the player data interface 2 is also Here, the user is convenient to change the content, the player is connected to the speaker 6 through the built-in audio output line, thereby realizing the sound output, and the voice control switch 12 can also control the switch of the player, and when the external strong sound source is received, the music is turned on. In the middle of the chassis of the vehicle body, there is a main and auxiliary electric motor 3, and after starting, the main motor moves back and forth by driving the transmission rod 4 or the spring 4 moves back and forth, thereby driving the fixing to the transmission rod 4 or the spring 4 [suspended by the suspension rod 19 in the sleeve The cradle 7 in the cylinder 14] the cradle 7 reciprocates linearly back and forth, the secondary motor drives the wheel forward through a mechanical transmission, and the cradle can also be shaken by the rocker, and the handrail is Between the body and the sun canopy mosquito coupling ring 5 and the vehicle body 1, the armrest 15 and the vehicle body can mosquito sun canopy 5 and a multi-angle locking with the vehicle body, the wheel and the vehicle body can be the same as the connecting portion

Designed, the wheels can be locked in a variety of ways in a variety of ways, including

First, the wheel (9) is a supermarket shopping cart wheel, with a non-slip design, using the well-known supermarket shopping cart wheels (such as the wheel is designed to prevent its movement on the escalator) and the supermarket shopping cart body and wheel connection Similarly, the surface of the wheel has flanges or ribs that fit on the bumps or grooves on the escalator surface. When the cradle is pushed onto the ramp escalator in the supermarket, the cradle is stuck on the escalator. No longer moving, the structure of the wheel is the same as the well-known supermarket shopping cart wheel, is a universal caster, the principle is the same as the universal caster of the well-known supermarket shopping cart, see the attached

2. The bottom of the bassinet and the cradle bed of the present invention (the lower part of the vehicle body) has an anti-skid device 29 (see FIG. 12 for the structure). When the user presses the anti-skid switch on the armrest, it protrudes from the axle or Ground contact, it is a long strip shape, which protrudes into the groove of the axle and sticks to the axle, so that the cradle or cradle axle will not roll again, so that the anti-skid and brake are an emergency brake device, due to The axle is caught by the anti-slip device, thereby preventing the wheel or the crawler from moving, and there is a groove in the middle of the cradle bed or the cradle axle. As shown in FIG. 12, the anti-slip device is switched on the cradle and the cradle bed armrest when the user presses the handrail again. When the anti-skid switch is turned on, it is retracted, and the stuck axle can be rolled because the insert of the anti-slip device is withdrawn, and the insert is marked 335, so that the wheel can roll again and the vehicle can move again. The anti-slip device is a long strip of steel. The invention is called a tab. When the user presses the switch on the armrest or the handle, the tab extends obliquely downward, and is embedded in the groove of the axle to catch the axle. live Wheels, if the user wants to loosen the anti-slip device, then press the switch again, the insert is reset, the insert is separated from the groove of the axle, and the wheel can be rolled again.

The design of the wheel (9) and the design of the wheel (9) and the body connection mode and the wheel of the supermarket shopping cart (such as a special universal caster with surface grooves or ridges for supermarket shopping, such as the well-known supermarket shopping The structure of the wheel of the vehicle is the same as the connection method of the body of the supermarket shopping cart. The wheels (9-1) and (9-2) are wheels that are sleeved inside the crawler belt, and the outer surface thereof can be designed with grooves or protrusions. The wheel and the track are engaged with each other, the design of the wheels 9-1, 9-2 and the design of the wheels 9-1, 9-2 and the track connection mode, and the crawler type walking device and the car of the cradle and the cradle bed of the present invention. The body connection design can be the same as that of the known (civil or toy or child or military) tracked or half tracked vehicles, and the similar connection method of the tank and tracked armored vehicles.

The design method of the crawler type walking device in the middle of each embodiment and the driving device (such as the design principle of the motor) can be designed by referring to the well-known various types of crawler vehicles or half crawlers for the design of the transmission device and the brake device and the vehicle body structure and the remaining components. Technical solutions for vehicles and electric vehicles,

The bassinet and cradle bed can be used as a cradle when not driving, and because the sidebar of the car body adopts a segmented sleeve design, it can also be designed with a tie rod or a fixed screw hole positioning rod. In order to connect each other through the screw holes, the lower part of each side rod is nested with the upper part of the lower side rod, and the two side rods that are connected between each other are overlapped by tightening the side rods with adjusting screws The partially overlapping positioning holes are fixed by screws, and the bottom plate is divided into four pieces. The bottom plates partially overlap each other. When the two bottom plates are moved to a predetermined position, the screw positioning holes (20) of the two plates overlap, and the adjusting screws are used. 23 screwing and fixing, the height and length can be adjusted by screws, and the screw 23 can be controlled by screwing or unscrewing the screw 23 at different positions of the side rod 18 and the chassis 17 and the like. For the purpose of large and small body change, as the improvement, the user can use the common simple tools available on the market according to the instruction manual, such as a screwdriver (no need for additional equipment), and change the length and height of the car body and the size of the cradle body as needed, the cradle, such as the main and auxiliary Motivation 3, and reduce the size of the car body, the user can use it to make room, reduce the car body and then reduce it to a walker, such as (can also reverse the large basket after the cradle is removed and fixed to four side bars Upper) When the body size is extended and widened, it can be turned into a child bed frame. If the car body is pulled up, it can become a storage closet. Anti-mosquito sun protection canopy 5 and cradle 7 and sunshade cover 37 and other components can be removed and washed, and through the player data interface (2), the playback content can be changed at any time, the voice control (switch) 12 is optional, the user is pushing When the car is in use, the small lamp 25 can be used for the road. The snacks and diaper boxes not shown in the figure can be hung beside the cradle, and the conduction device 28 and the battery pack 30 are placed in the lower part of the large basket, and the large basket 24 can be placed in the basket and can be activated. The small fan 27 and the small mosquito lamp 26 are used to repel mosquitoes to prevent the child from feeling uncomfortable. The cradle 7 is made of a foldable or telescopic material or a telescopic structure (the one end can be fixed to the side of the car, the other end can be pulled open, and the body is suspended. The hook on the hook forms a cradle, which can be restored when not in use. The inner pad and the pillow (not shown) can be pressed into a flat shape or the cradle carrying the child's cradle after moving the cradle to one side. The product is placed for use as a shopping cart, and the motor can be divided into a main motor driven wheel and a secondary motor to reciprocate the electric cradle. As an improvement, the cradle can have the following design, such as

1, the number of wheels can be increased, correspondingly, the installation position of the wheel should also be increased,

It is possible to increase the number of wheels 9, increase the mounting position of the wheels 9, or increase the number of wheels (such as wheels 9-1 or 9-2) that are placed inside the track, or increase the number of wheels inside the track. The installation position of the wheel, the specific installation method is shown in the attached drawing.

The walking device of the multifunctional bassinet can be selected by the user to use a multi-wheel or half-track or crawler type walking device, and the user can press the switch on the handrail to raise or lower the hydraulic control system of the bassinet or the cradle bed. The walking device is a crawler belt type walking device, and the specific principle is as follows.

The multi-wheeled traveling device, that is, the traveling device having a plurality of wheels, the number of wheels can be reduced or increased according to actual needs, and the multi-wheeled traveling device can be provided with a plurality of wheels on the left and right sides of the vehicle body, specifically Two technical solutions,

A first type of multi-wheel type traveling device, characterized in that

A total of four train wheels are arranged at the bottom of the vehicle. The installation position of the two columns in the middle is asymmetric with the installation position of the two train wheels on the side. The installation position of the two train wheels in the middle is pushed back compared with the installation position of the two train wheels on the side or It is the distance of no more than half of the wheel ahead. If the motor is driven, the motor drives one pair of wheels. The pair of wheels are driving wheels. The pair of wheels are separated on the left and right sides, and the middle of them is interconnected by an axle. The axle is provided with a groove so that the anti-slip device extends out of the insert into the groove of the axle to perform braking, and a wheel 9 which can be raised (with hydraulic or rotary device) or lowered is provided in front of and behind the chassis, the present invention The anti-slip device is an emergency brake, reference numeral 29, see FIG. 8-1.

2. A second type of multi-wheel type traveling device, characterized in that

Two train wheels are installed on the left and right sides of the vehicle. The installation position of the left or right train wheel is lower than the installation position of the opposite train wheel or the distance of no more than half of the wheel. If the motor is driven, the motor Driving one of the wheels, such as the last wheel, a wheel 9 is provided in front of and behind the chassis, and the wheel 9 can be raised and lowered, see FIG. 17, for example, 3. A third multi-wheel type traveling device characterized in that

A total of four train wheels are arranged at the bottom of the vehicle. The installation position of the two columns in the middle is asymmetric with the installation position of the two train wheels on the side. The installation positions of the two train wheels on the side are also asymmetric with each other. The two train wheels in the middle The installation position is lower than the installation position of the two train wheels on the side or the distance of no more than half of the wheels ahead. The same is true for the two rows of wheels on the side. If the motor is driven, the motor drives one or more of the wheels. The one or more wheels are driving wheels, and the writing drive wheels can be separated from the left and right sides. They can be connected with axles or without axles. Anti-skid devices can be arranged above them, and the axles can be provided with grooves to facilitate the arrangement. The anti-slip device extends out of the insert into the groove of the axle to perform braking, and a wheel 9 which can be raised (with hydraulic or rotary device) or lowered is provided in front of and behind the chassis, and the anti-skid device of the present invention is an emergency The brake, reference numeral 29, see FIG. 10-2,

4. A fourth type of multi-wheel type traveling device, characterized in that

There are train wheels on the left and right sides of the vehicle, which are symmetrically arranged. One or a plurality of independent wheels are installed in the middle and the back, and the middle and left and right wheels are asymmetrically arranged, as shown in FIG. 10-1.

5. The multi-wheel type traveling device according to the above aspect 1-4, wherein the vehicle can be driven by a hub motor or a wheel motor, the motor can be controlled by a computer, and the wheel can be Separately mounted on the bottom of the vehicle, the wheels can be mounted on the bottom of the vehicle with a separate spring suspension system. The wheels can be driven by an internal combustion engine or an electric motor. One or two pairs of wheels arranged side by side are used as drive wheels. Alternatively, an existing motor drives one or more of the wheels as a drive wheel.

The position of the right wheel is set at a distance from the radius of one of the wheels of the left wheel, that is, the position of each of the right wheels is more than half of the wheel of the left wheel set, see FIG. 17, in other words, The mounting position of each wheel on the right side is installed at a distance from the left wheel to the radius of one such wheel. For example, it is also called the installation position of the first wheel, and the installation position of the first wheel on the left side. The back is equivalent to the distance of one wheel radius, and the diameters of the left and right wheels are all the same, and the reverse can also be set, that is, the installation position of the first wheel on the left side refers to the right side. One wheel retreats to the position of the first wheel diameter on the left side of the left side. The installation positions of the other wheels are similar, and the distance between the wheels of each group of wheels can be the minimum distance that can ensure the normal operation of the wheel. These wheels, that is, two train wheels mounted on the left and right sides of the bottom of the vehicle, may each have three or four, and the present invention will be referred to as a wheel set, a cradle bed or shake according to the present invention. The second technical solution of the multi-wheeled walking device of the car or the stroller is that the position of each wheel of the right wheel set is lower than the position of the left wheel by half of the wheel diameter, that is, the first one on the right side. The wheel is half the wheel behind the first wheel on the left side, the second wheel on the right side is installed half the wheel behind the installation position of the second wheel on the left side, and the other wheels are pushed in the same way, and vice versa. The mounting position of each wheel is pushed forward by half the road diameter than the mounting position of each wheel on the left side. Also allowed,

The technical solution of the present invention also has the following technical features.

An electric motor and various systems thereof are mounted on a vehicle chassis such as a detachable bassinet disclosed in the present invention. The power of the electric motor can be transmitted to the front gearbox through the transmission shaft, and then transmitted to the driving wheels of the crawler type traveling devices on both sides, or the transmission wheel can be directly transmitted through the transmission device without passing through the transmission. The reference numerals are 94,94001,94011,94012,9-1,9-3 or 9-2, or 9-3, which can be fitted with a hub motor and a wheel motor on their wheels. These are two common types. The motor directly drives the working mode of the wheel. The principle is the same as that of the common wheel motor drive wheel and the wheel motor drive wheel. The motor is a DC motor, and the motor can be a central motor or an independent motor. The driving wheel, the motor and the entire driving device and lifting device, and the expansion and contraction of the lighting device and the walking device and the mop chair can all be controlled by a computer, and the computer is controlled by the user through a button on the control panel, the driving wheel (drawing Marked as (9-2) to move the track, you can set the pulley and the induction wheel, or you can just set the drive wheel and the load wheel, you can set the wheel 9-1 to The induction wheel may also be other than the wheel 9-2. All other wheels that are sleeved inside the track are all road wheels, and the driving wheel and the induction wheel and the carrier wheel and the road wheel are all sleeved on the track (reference numeral 222) Or 2221, or 222111) internally, to propel the vehicle forward. The crawler type walking device may have a differential steering function and a corresponding device. In the middle of the crawler type walking device, a driving wheel, a weight wheel, an induction wheel, a driving wheel, The load wheel is arranged in the middle of the crawler belt. Each crawler type walking device can have 4-8 front and rear load wheels, and can also be equipped with a support pulley. The crawler type walking device can adopt a torsion bar suspension device (attached The figure is attached to the vehicle body. The crawler type walking device can be made of rubber. The track type walking device can also be connected with the car body by a spring-type suspension device. The wheel can be installed in the middle and front and rear of the chassis. 9)

According to the first type of multi-wheel type traveling device of the present invention, the traveling device can also be installed in the cradle bed and the cradle according to the present invention. The specific technical solution is as follows.

The wheel of the cradle bed or the cradle is mounted symmetrically on the left and right sides. As shown in FIG. 8-1, between the left and right sets of wheels, there are also wheels 9 and two other train wheels, which are arranged asymmetrically. 8-1, each of the front and rear wheels 9 has a lifting function, and the user can lift and lower the wheel 9 by pressing a switch on the armrest.

When the user pushes the bassinet or the cradle or the basket or the big basket to the automatic ramp, press the switch, the lifting device puts down the wheel 9, so that the cradle or the cradle can be fixed on the automatic break of the supermarket, no There will be a slope,

The wheel of the bassinet according to the present invention can be either a conventional bassinet wheel or a grooved, ribbed wheel identical to the wheel 9 (reference numeral 9401), and the said bassinet Or a cradle bed or a cot or stroller,

It is also possible to provide a pair of casters dedicated to supermarket shopping carts such as wheels 9 in front of or in the middle of the two train wheels.

The structure of the multi-wheel type walking device can refer to FIGS. 17, 8-1, 23, 5, 25, and in the middle of some drawings, the left and right sets of ordinary cradle beds or cradle wheels of the vehicle bottom are shown, and also The front and rear wheels of the two sets of wheels are in the middle or front and rear, and the side of the multifunctional cradle body has a side bar.

It is also characterized by:

A pair of wheels 9 may be disposed in front of and behind the crawler type walking device or the multi-wheel type traveling device. The bottoms of the bassinet and the cradle bed of the present invention may be only the wheels in the middle of the left and right sets of cradle beds or cradle wheels. 9, it is also possible to set the wheel 9 before and after the two sets of wheels, or to set the wheel 9 in between.

All of the cradle or cradle can be fitted with an electric or hydraulic lifting device (reference numeral 615) or a human-powered slewing device for lifting the wheel 9 or support foot (reference numeral 509) if installed simultaneously Multi-wheeled and crawler type walking device, then, the crawler type walking device and the wheeled traveling device walking device can be installed in the lower part of the lifting device, and the crawler type walking device and the multi-wheel type traveling device are all connected with the lifting device when the user To push the bassinet or cradle bed with the ordinary bassinet wheel 94 to support the body, you can lower the bassinet wheel 94 or 94001 as the only walking device, and also raise the cradle bed or the supermarket at the bottom of the cradle. The wheel (9) and the support foot (reference numeral 509), when the user goes to the supermarket automatic ramp, when using the supermarket shopping cart wheel (9) to support the bassinet or the cradle bed, you can press the handrail. The switch acts on the lifting device through the conducting device, lowers the wheel (9) by the action of the lifting device, or directly dials the rotating device, lowers the wheel 9 when the user leaves In the city, press the switch on the armrest to raise the wheel 9, and when the user is at home, press the switch on the armrest to lower the support foot and replace the wheel and crawler type with the support foot. Support the cradle bed or the bassinet,

In the cradle bed and the bassinet of the present invention, the electric lifting device may not be provided, but the blade lifting and lowering of the anti-skid device may be operated by manpower, the lifting and lowering of the wheel 9 is controlled, and the lifting and lowering of the supporting leg is controlled. The specific technical solution is as follows,

The inside of the anti-slip device is provided with a spring, and the insert piece is fixed to the inside of the anti-slip device by a spring. The whole anti-slip device is a pressing tool provided with a blade at the front stage, and has a pressing pedal at the top end and a tab at the front end. The principle is similar to that of a push-type ballpoint pen. When the user needs to lower the insert to insert the groove of the axle, the pedal can be stepped on the pedal of the push-type anti-slip device, and the push-type anti-slip device pushes the tab down under the external force of the pedal. Out, the insert is extended and inserted into the groove of the axle, and the axle is no longer rotated. Referring to FIG. 12, if power is used for control, when the user gives an instruction, the insert extends downward and is inserted into the recess of the axle. The groove, thereby catching the axle, so that the axle no longer rotates,

The lifting and lowering of the support legs and the lifting and lowering of the wheels 9 can also be designed such that the support legs and the wheels 9 and the anti-slip devices all adopt the principle of the push-type switch lamp to design the holy sword device.

In addition, an emergency brake shoe (reference numeral 501) may be disposed at the bottom of the cradle bed and the cradle according to the present invention, and the lifting device of the object is designed by using the above-mentioned push-type switch principle. When the brake shoe pedal is stepped on, the brake shoe (reference numeral 501) protrudes and rubs against the wheel, causing the wheel to stop rolling.

When the user wants to push the bassinet and the cradle bed to climb the building, the switch can be turned on and off, or the multi-wheeled walking device can be put down, and the multi-wheeled walking device is set by two or more asymmetrically arranged left and right. The group of wheels is composed, and the wheels are arranged by an asymmetric arrangement.

1. A switch capable of implementing the relevant function is placed on the armrest or in the operating device. The user can select the following working mode by controlling the switch on the armrest or the operating device or directly operating the relevant device.

A telescopic or folding cradle, B changes the type of walking device, C changes the power source of the cradle and cradle bed:

Users can choose the following technical solutions, 1, for electric drive, 2 for hand push;

The towed chair refers to a foldable (or unfoldable) chair that can be inserted into a slot (reference numeral 8787), and the seat back can be placed independently inside the slot, and there is a cassette under the back of the chair. When the back of the seat is inserted into the slot on the seat, the seat and the support block are articulated by the shaft, which can be propped up to form a seat, or can be laid flat, inserted into the slot, seated and supported. The blocks are linked to each other by an axis. When the chair is not in use, the seat bench (reference numeral 77665) and the support block (reference numeral 77663) can be placed. When used, the seat and the support block are supported, and the support block 1 is supported. The cassette is inserted into the slot on the carriage under the mop chair. The lifting device of the wheel 9 according to the present invention is composed of a piston (23001), a screw (23005), a solenoid (23002), and a nut (23001). The wheel base (333), the wheel frame (336), and the wheel (9) are characterized in that the wheel is lifted and lowered by a rotating screw. For details, see FIG. 18-2. This paragraph is an accurate description of the technical solution shown in FIG. 18-2.

The cassette and the card slot according to the present invention may be a male buckle and a female buckle. The luggage baby carriage of the present invention is volley and only has a lifting device. The lifting device may be a support rod and supports The rod is a lifting rod. The lifting rod has a shaft hole. The inner wall of the bag has a latch. Pulling the lifting rod high and inserting the cassette into its different shaft holes (card slots) can stretch the upper and lower parts of the bag to different lengths. The distance of the lifting rod is a hollow sleeve-like column body, which can be shortened and elongated. The upper part and the lower part of the bag can be hinged by hinges, and the bag can also be pulled directly by human force without the aid of the lifting rod. Open the zipper, stretch it, set the zipper on the bag, the zipper is installed on the outside of the soft part of the bag, pull the zipper all apart, the upper and lower parts of the zipper are separated, so the soft part of the bag can be The bag can be a travel bag that can be lengthened or reduced by the opening and closing of the zipper, and the bag can be provided with a pull ring. The drawing 18-2 of the present invention can also be used at the same time. Have performance The utility model of the belt type walking device and the wheeled bicycle or the crib of the wheeled walking device is used for lifting the crawler type or the wheeled walking device, for example, fixing the crawler type or the wheeled walking device or the supporting leg to the lower end of the connecting rod 60166 The connecting rod can be connected to the screw, or the screw can be regarded as a connecting rod, and the surface of the screw is threaded, and the thread and the thread on the inner surface of the screw are matched with each other, so that the screw can be fixed and lifted at any height inside the screw, through the rotating screw The upper nut is used to realize the lifting and lowering of the screw and the device fixed at the lower end of the screw, so that the user can select different walking devices to support the body or the bed body, and the crawler type walking device can have three or five intermediate grooves. The crawler wheels (such as the wheels 9-1 or 9-2) and the crawler belts with the convex teeth in the middle are hinged to each other (such as the object pointed by the reference numeral 222) and the crawler belt are combined with each other. One or two of the wheels are driving wheels, and one of the wheels that are respectively mounted inside the left and right tracks is a driving wheel, and the grooves of the wheels are just right. The protruding teeth are matched with each other, and the driving wheel may be a driving wheel connected to the driving axle, if it is a crawler wheel set inside the crawler belt, such as the wheel 9-1 or 9-2, because the crawler wheel is mounted on the driving axle At the left and right ends, when the motor drives the drive axle to rotate, (for example, if the motor directly drives the drive axle to rotate, or if the drive axle is driven by the shift gearbox, or the motor is connected to the shift gearbox to drive the axle to rotate) The axle drives the driving wheel to rotate, and the driving wheel drives the track to rotate. (The wheel motor or the wheel motor or the central motor can be used to directly drive the wheel disposed inside the track or the wheel not inside the track to drive the vehicle to travel. The said hub motor or the wheel side motor may be an outer rotor, which directly mounts the rotor of the motor on the hub, the motor drives the rotor to rotate, and the rotor drives the wheel to rotate, thereby realizing the vehicle traveling, if it is like a wheel 94, 94011, 94001, 94012, etc., which are not set inside the track, then when the motor The driving axle rotates, and the driving axle drives the driving wheel to rotate, and the driving wheel directly drives the vehicle to travel. As shown in FIG. 25, the legs of the towing chair or the wheelchair can be directly connected to the wheel 94011, and the wheel 94011 can be a universal wheel. The hydraulic system of the invention has a hydraulic cylinder connected at one end and a device for lifting and lowering at one end. The lifting and lowering of the cylinder can be achieved by loosening the cylinder or pressing the cylinder, and two or more motors can be used to drive the left and right respectively. The wheel, as described in the present invention; the upper portion of the crawler type walking device may be provided with a guide rail or a hook, and the crawler belt may be sleeved inside the guide rail or the hook. The wheel of the present invention may be equipped with a shock absorbing spring, and one end of the shock absorbing spring is connected to the vehicle body. One end of the wheel is connected to the wheel. In the multi-wheel type traveling device of the present invention, each wheel can be connected to the vehicle body by a spring bracket (a wheel bracket with a spring), and the wheel is sleeved on the driving axle of the motor. When the motor rotates, the rotor drives the shift gear of the shift gear box to rotate, and the gear drives the axle to rotate. The axle drives the wheel to rotate. In the technical solution of the multi-wheeled traveling device, the wheel can be fixed to the wheel seat of the lower part of the vehicle body by using a wheel frame with a spring, and the wheel is mounted with a hub motor or a wheel motor, and the motor is The rotor directly drives the wheel to rotate. The motor can be entirely used by the central processing unit of the bassinet or cradle bed or crib or crib of the present invention (a control panel that can be accessed by the user through the armrest or the joystick) Controlled by the computer), the motor drive of the present invention can be replaced by an internal combustion engine drive, said crawler type walking device, the manner of folding the armrest, the supporting foot, the structure and storage mode of the sunshade, and the miniature or small air conditioner. The structure of the bassinet or crib or cradle bed or crib of the present invention is as shown in the drawings, and may be a rectangular frame structure, which is only equipped with one (rectangular A sunshade that can be engaged with the card slot of the body of the body bed, and the crawler type walking device can be juxtaposed with the wheeled walking device. Or the bottom of the bed, the wheel shelf and the lifting device are mounted on the chassis, the lower end is connected to the walking device, the upper end can be connected with human or electric operating equipment (such as a handle, or a hydraulic device or a computer), and the sunshade is stored in a manner with a known baby. The sunshade of the vehicle is stored in the same manner, and the working mode of the motor or the rocker is the same as that of the known motor and the rocker. The baby carriage or the bassinet according to the present invention may also have the following technical features. The fitted pocket (like a canvas pocket) has a continuous circumference for carrying the baby 2, or a seat pocket, for placing the baby,

There is also a body and bed body that can be fitted with a seat belt to protect the baby's safety and can be adjusted to a reclining or reclining position. The frame (body) has one or more handles for pushing.

Cushion, canopy (also known as sunshade, also called the ceiling), foot pedal, backrest, interchangeable, steering joystick. The sunshade can be a common ceiling, and the Kerr consciousness can not be stored in a fixed manner, or can be folded and stored. On the side of the bassinet or the stroller, there is a sunshade holding compartment, and the sunshade can be placed after being rolled up. In the accommodating compartment, it can also be just placed on the side of the body or the bed after the sunshade is folded. The folding method is the same as that of the common baby car roof. The support bar can be placed inside the canopy. Flat or erect, when the support bar is flat, the ceiling is folded. When the support bar is erected, the ceiling is opened, and the support bar has a click, which can be used at different angles to the card on the body or crib bed. The slot is engaged to fix the ceiling, and the stroller shown in FIG. 5 is taken as an example to illustrate how to fold the stroller.

The card slot will be opened, the cassette will be withdrawn, and then the body will be pressed down to make the body lower, then the armrest or joystick will be rotated forward along the adapter ring to the stroller body, and then the armrest or joystick will be The cassette is locked with the card slot of the other end of the stroller (the front end), or the body can be folded and erected, and the body is folded to be square.

The bassinet and the stroller or the crib of the present invention have a brake device, and the place where the baby is placed has a safety fence. The height of the bassinet and the crib and the stroller can be screwed and screwed through different positions in the body or the bed. Adjusted by the bite, the skeleton of the body or the bed body can be iron pipe or aluminum pipe, and the brake device of the common baby carriage can be installed, the brake device can be braked on one foot, the brake can be braked, or the double brake device can be installed. This is also a common device for braking the baby carriage. There is a linkage lever between the two brake pedals. If you press the brake pedal on either side, you can brake the two wheels at the end of the vehicle. The body or bed can be installed to prevent pinch devices. Some specific small technical solutions within the various technical solutions can be used interchangeably among different technical solutions, that is to say, some of the technical solutions for the bassinet or the cradle bed are described in the embodiment examples or the drawings of the specification. It can also be used in a stroller or a crib. For example, FIG. 6 is a technical scheme of a crawler type bassinet or stroller with a towing chair, but the specific technical solution with a towing chair can also be used for attachment. The technical solution of the multi-wheeled bassinet shown in FIG. 5 is similar. The pedal-type or the push-type brake device in the technical scheme of the multi-wheeled bassinet mentioned in FIG. 5 can also be used for attaching. FIG. 6 shows the technical solution,

The technical solution of FIG. 25 is to set a cradle or a stroller inside a bag that can be pulled or folded with a zipper, so that one bag becomes a cradle or a stroller, and the zipper is opened, and the bag is opened. When the support rod is erected and the zipper on the outer surface of the upper part of the bag is pulled out, the bag is raised, and the upper half is the ceiling of the stroller or the bassinet, and the hinge is provided on one side, and the upper and lower parts are hinged. The bag is hinged, and a connecting ring is arranged on one side, and a joystick or a handrail is mounted thereon. The bag is opened, and the joystick is straightened to become a device for manipulating the baby carriage or the bass car. If not, the joystick is turned. The ring is folded into the inside of the bag, the support rod is lowered, the baby is taken out from the middle of the cradle inside the bag, the upper part of the bag is combined with the lower part, and the zipper is pulled, and the bag is combined and integrated into the bag. The outer surface of the upper and lower parts is also provided with a zipper for the volume of the telescopic bag. The part where the zipper is located is the soft material part of the bag. The principle of the telescopic case is as common as the big one. Zipper bags use a telescopic line to its volume is a way of technical solutions,

In the middle of the technical scheme of the bassinet or the stroller or the crib or the cradle bed of the present invention, the air conditioner, the electric motor, the anti-skid device, the push brake device, the wheel base, the battery, the transmission device, the rocker, the shifting gear Gearboxes, adapters, etc., have their own outer edges with legs (threaded holes on the legs) or screw holes, and the screw holes on the outer casing correspond to the screw holes on the body or bed, with screws (or screws or Insert the screw hole into the screw hole and tighten the screw (or screw or bolt) to fix the above parts to the body or the bed. You can fix the hub motor or the wheel motor with screws (or screws or bolts). Inside the screw hole of the wheel hub, the motor, the adapter, the battery, the transmission device, the anti-slip device, and the extension device can be fixed on the chassis of the vehicle body or the bed body, and the air conditioner is screwed to the battery at the rear of the vehicle body or the bed body. In the upper position, there is a foot on the outer casing of the air conditioner, and a screw hole is arranged on the leg. The screw hole is corresponding to the screw hole on the body or the bed body, and the screw (or screw, or bolt) is inserted and tightened, that is, The air conditioner can be fixed on the vehicle body or the bed body, and the storage box of the sun shield can be fixed to the front end of the vehicle body or the bed body in the same manner, and the above-mentioned various electric components can be connected to the battery and the control panel in parallel. It can also be connected to the battery and the control panel through the conducting device, so that the above components can accept the user's instructions and obtain the power supply of the battery, the cradle is suspended from the upper part of the body or the bed body, the rocker is below it, and the specific components are installed. The manner and position are determined by the manufacturer, and the technical effects required by the present invention are determined. Although the present invention has only exemplified the above specific embodiments, it does not indicate that the present invention has only these technical solutions, and any The optimization and improvement of the structure, shape and composition of the above-mentioned technical solutions of the present invention based on the concept and principle of the present invention, and all the embodiments and modifications proposed based on the concepts and principles of the present invention are The scope of the invention is intended to be included in the appended claims.

Referring to FIG. 27 of the present invention, it will be appreciated that the present invention introduces a new type of shopping cart having a wheel reference numeral 94 and a multi-wheeled walking device of the cart, as will be appreciated from FIG. 28, the present invention also A new type of wheelchair, the wheel of which is also a multi-wheeled walking device, the meaning of the reference numerals is the same as the meaning of other reference numerals of the present invention, for example, 94 are all pointing to the wheel, and 9 are pointing to the supermarket for lifting. The wheel of the car, 213 is pointing to the joystick, this wheelchair can be driven by the swimmer, so it has a steering wheel, 11112 points to the steering gear, 336 points to the wheel shelf, one end of the wheel frame connects the wheel, one end connects the wheel seat on the vehicle chassis, the wheel The seat is fixed on the chassis or the side bracket of the vehicle, and the center is a wheel shelf, and the center wheel shelf is directly connected to the steering gear above the wheel seat, and the lower end of the steering gear can also directly connect the connecting column of the wheel, the steering wheel is attached The figure is labeled 31, and the handrail is marked as 15, and the above-mentioned vehicles can all adopt a multi-wheel type walking device, and the steering device thereof It is placed above the wheel base on its wheel frame and can be fixedly connected with the wheel frame. It can also directly connect the wheel connection column to the steering device. The steering device is a steering gear. The steering of the steering gear can be controlled by the user by mechanical control or computer. When the user controls the steering of the steering gear through mechanical or computer, the steering device will drive the wheels to turn together to realize the steering of the vehicle. The wheels can be equipped with a hub motor or a wheel-side motor. These motors and steering gears all pass through the power cord. Connected to the battery and powered by the battery, the hub motor and the wheel motor can both have their own batteries. The hub motor and the wheel motor can be connected to the computer through wires (data lines), and receive commands from the user through the computer. A microprocessor can be arranged inside the wheel motor, and the steering gear can also be connected to the steering wheel only by mechanical transmission means. The wheel can be installed under the bottom of the vehicle or under the chassis, or can be mounted on a fixed shelf on both sides of the vehicle body, and its structure Is the wheel mounted on the wheel shelf The wheel frame is mounted on the lower end of the wheel base. The wheel base is mounted on the fixed bracket on the side of the vehicle. A steering gear is arranged above the fixed shelf. The wheel shelf in the center of the wheel seat is connected to the steering gear on the side fixing bracket, and the wheel base is fixed on the wheel bracket. The side of the vehicle is fixed on the bracket or the chassis of the vehicle, but the wheel rack at the center of the wheel mount is rotatable. The wheel rack is directly fixed to the bottom of the steering gear, following the steering of the steering wheel, and the multi-wheel type traveling device introduced by the present invention The wheel can be installed on the lower end of the vehicle chassis or on the fixed shelf on the side of the vehicle. The technical scheme of the multi-wheeled traveling device is divided into A, which consists of two train wheels, and the middle can also be A plurality of wheels are arranged, and the positions of the wheels and the wheels can be symmetric with each other. Each wheel can be mounted by a separate suspension to install a vehicle de 1 chassis or a walking bracket (lower end), which can be fixed to the wheel frame by wheels, and the wheel frame is fixed to the wheel frame. Wheel base, wheel base chassis, wheel frame fixed to the steering gear, steering gear Located above the wheel base, the wheel mounts the hub motor and the wheel motor. The steering gear can be controlled by the user through mechanical means, or can be controlled by the user through a computer. The hub motor and the wheel motor can be used. Through the computer control, the hub motor and the wheel motor have a power line connected to the battery and are powered by the battery. The hub motor and the wheel motor are connected to the computer through the data line, and the user can control through the computer. The operation of the hub motor and the wheel motor, the steering gear can also be powered by a battery, and the steering gear can be connected to the computer through a data line.

The following three technical solutions are identical to the contents of the above technical solution A except for the differences between the respective technical solutions indicated above.

B. There are multiple train wheels. The installation position of each train wheel is asymmetric with the installation position of the wheel next to it. It consists of two left and right train wheels, and their installation positions are asymmetrical.

C, there are two train wheels on the left and right, and their installation positions are symmetrical to each other.

D, there are three wheels, which can be installed two in front, one in the back, one in the front, and two in the back, see FIG. 29,

The wheel of the multi-wheel type traveling device can also be driven by a central motor by driving an axle, and the above various vehicles or beds can be mounted with a side fixing shelf.

1. The utility model relates to a crawler type multifunctional cradle, which comprises: an armrest, a vehicle body, an electric motor, a suspension rod or a spring, an anti-skid device, a mechanical transmission device, an axle, a cradle, a crawler type walking device, a wheeled walking device, a lifting device, a supporting foot, the wheel 9 supermarket shopping cart wheel, rocker, air conditioner, sunshade, spring card slot, lifting device lifting device, battery pack, insert, large basket, etc. It is characterized by: The armrest is on the back side of the car body, Said car body is in front of the armrest, Said motor is at the bottom if the car body, The spring column is connected between the vehicle body and the wheel. The anti-slip device can extend the insert into the groove of the axle, The wheel 9 is the supermarket shopping cart wheel. Said rocker is used to swing the cradle, The air conditioner is a small air conditioner. The lifting device can be used for lifting the wheel 9 and the brake shoe and the supporting leg. The brake shoe is mounted with a friction block. The friction block can be used to prevent the wheel from rolling by friction. The sunshade is mounted on the front of the body of the bassinet. The spring card slot is mounted on the surface of the body of the bassinet. Said supermarket shopping cart wheels for wheels (9) The crawler type walking device is at the bottom of the body and the big basket and the tow basket. The bottom of the tow basket is equipped with a wheel (9-4), which has the same structure as the wheel 9. The cradle is suspended in the sleeve (14) by a suspension rod (19), Said motor is connected to the axle by a mechanical transmission, The rocker can be powered by the battery pack (30) and shake the cradle. The wheel of the crawler type traveling device is connected to the mechanical transmission through the axle. Said motor is installed at the level of the bassinet. The inside of the car body is equipped with a large basket. The battery pack is characterized in that it has a real-time payment device in the lower part of the large basket.

2. A semi-track type multi-functional cradle bed or crib or bassinet or stroller, including: handrail, bed body, electric motor, suspension rod or spring anti-skid device, transmission gear box, mechanical transmission, bed plate, axle, cradle, Wheeled walking device, crawler type walking device, lifting device, support foot, movable wheel 9 supermarket shopping cart wheel, rocker, air conditioner, sunshade, spring card slot, lifting device lifting device, battery pack, insert, large The composition of the basket, It is characterized by: The walking device is composed of a crawler type walking device and a wheeled traveling device. The crawler type walking device may include a crawler belt (reference numeral 222), wheels (reference numerals 9-1 and 9-2), a shock absorbing device, a torsion bar and the like. The wheeled travel device can include wheels 94 and wheels 9, The control panel is mounted above the armrest or the joystick. The armrest or the joystick is on the back side of the bed, The bed plate can be either a rectangular shape with a hollow wooden board in the middle, or the side panel of the large basket can be laid flat, and the side panel can be placed on the body of the cradle or the bassinet or the crib or the stroller or a flat plate formed on the inside of the bed, The gearbox is similar in structure to a common gearbox of an electric or internal combustion engine, and has a screw hole in the outer casing, and the screw hole is screwed into the screw hole of the bassinet or the stroller or the crib. The bolts or screws are tightened to secure the gearbox to the bottom or chassis of the bassinet or stroller or crib. The mechanical transmission can be comprised of a variable speed gearbox and a drive axle. Said bed or body is in front of the armrest or the joystick, The armrest or the joystick is connected to the body or the bed through a connecting ring. Said motor is at the bottom of the body or bed, The spring column is connected between the bed and the wheel. The movable wheel is mounted on the bottom of the cradle bed. The spring card slot has a screw hole on the outer casing, and the screw hole corresponds to a screw hole of the bassinet or the baby carriage or the baby bed, and the screw or the screw is screwed, and the spring card slot is fixed to the bass car. Or a stroller or crib, The lifting device of the walking device refers to a hydraulic lifting device and an electric lifting device. The principle of the two devices is prior art and belongs to common knowledge. The lifting devices have a screw hole on the appetite of the lifting device. Corresponding to the screw hole of the bassinet or the stroller or the crib, screw in the bolt or screw and screw it to fix the lifting device to the bottom or chassis of the bassinet or stroller or crib, said battery pack The working principle and installation and fixing method are the same as the working principle and installation and fixing method of the common electric vehicle battery. The battery pack or the battery can be placed inside the battery compartment, and a spring or a compression spring can be arranged inside the warehouse for The battery is fixed, the top of the battery compartment has a cover plate, and the battery compartment has a connection port for allowing the battery to pass through the wires for supplying power to the various electrical components. The said activity wheel is the wheel of a bassinet or a stroller. The wheel of the bassinet or crib or stroller or cradle bed may be the same wheel as the known bassinet or stroller, and may be a pneumatic tire, which may be a rubber wheel. The above wheels are labeled 94 or 94011 or 94012. Use of the reference numeral 94 or 94011 or 94012, the structure of which can be the same as the wheel of a common bassinet or stroller, the wheel numbered 94 or 94011 or 94012, can be fitted with a hub motor or wheel motor, the motor directly drives the wheel to travel, Said moving wheel is exactly the same as the wheel of claim 1. There is an axle in the middle of the moving wheel. The anti-slip device is mounted on the chassis of a bassinet or cradle bed or a crib or stroller. The anti-slip device is provided with a tab. The anti-slip device can extend the insert. Said in the groove of the embedded axle, When the insert is inserted into the groove of the axle, the axle will be caught, so that the axle is not rotating, thereby preventing the wheel from rolling. The wheel 9 is the supermarket shopping cart wheel. Said rocker is used to swing the cradle, Said rocker is powered by a battery, The air conditioner is a small or miniature air conditioner. The air conditioner is powered by a battery. The lifting device is a hydraulic or electric lifting device. The hydraulic or electric lifting device can be used for lifting the wheel 9 and the brake shoe and the supporting leg. The brake shoes can be used to prevent the wheels from rolling by friction. The sunshade is mounted on the front of the body of the bassinet. The spring card slot is mounted on the surface of the body of the bassinet. Said supermarket shopping cart wheels for wheels (9) The crawler type walking device is at the bottom of the bed and the big basket and the tow basket. The bassinet or crib or cradle bed or stroller can be provided with a chassis. The bottom of the chassis is equipped with wheels (9-4), which have the same structure as the wheels 9. The cradle is suspended in the sleeve (14) by a suspension rod (19), The electric motor is connected by a mechanical transmission and drives the axle. The rocker can be powered by the battery pack (30). Said rocker can shake the cradle, The wheel of the crawler type walking device can be equipped with a hub motor or a wheel motor. The wheel of the crawler type traveling device can be directly connected to the motor through the axle, or can be connected to the shift gear box through the axle, and the shift gear box is connected to the motor. Said motor is mounted on the chassis of the bassinet. There is a large basket inside the bed. Said battery pack is in the lower part of the big basket, Said various prams or strollers or cribs, The utility model is characterized in that a real-time payment device is installed, and the real-time payment device has a screw hole on the outer casing, and the screw hole on the outer casing corresponds to the screw hole of the bass car or the baby carriage or the baby bed, and the screw or the screw is screwed. By tightening, it is possible to fix the real-time payment device in a bassinet or a stroller or a crib.

3. Multi-wheeled bassinet, consisting of real-time payment device, multi-wheeled walking device, wheel hub motor, wheel motor, wheel 9, small lamp, brake shoe, support foot, drag basket, large basket, air conditioner, motor, battery, rocker, sunshade, etc. It is characterized in that The hub motor and the wheel motor can be provided with a screw hole on the outer casing, corresponding to the screw hole of the wheel hub, screwed into the screw hole and screwed, and the hub motor and the wheel motor can be screwed. Fixed to the wheel, The brake shoe, that is, the push brake device, is provided with a screw hole on the outer casing, and the screw hole on the shell of the push brake device and the screw body of the bass car or the baby carriage or the crib or the cradle bed or the bed body Corresponding to the hole, screw in the bolt or bolt, tighten the brake shoe, that is, the push brake device is installed in the bassinet or the stroller or the crib, and fixed. The support foot can be provided with a screw hole on the outer casing, and the screw hole is corresponding to the screw hole of the bass car or the baby carriage or the crib body or the bed body, screwed into the bolt or the bolt, and the brake shoe can be tightened. Is a push-type brake device that is mounted on the frame of a bassinet or stroller or crib and fixed. The large basket is located under and around the cradle. The lower part of the cradle can be selected to install the crawler type walking device, or the multi-wheel type walking device can be installed, and the wheel can be mounted. The wheel can be similar to the structure of the wheel 9, and can also be installed. The wheel 94011 can be a multi-wheel type walking device as claimed in the preceding claim, wherein a screw hole is arranged on the frame, a wheel can be mounted on the bottom, and a frame has a screw hole, and the screw hole on the frame and the body of the bass car Corresponding to the screw holes, screw the screws or bolts to fix the large basket on the body or bed of the bassinet or stroller or crib. The side panels of the large basket can also be put down as a crib and cradle bed. Bed board, there is a hole in the middle of the big basket, which is convenient for the swinger to connect with the cradle. The said tow basket refers to a basket that can be fixed to the body of the bassinet or the bed of the crib by means of bolts or screws. The lower part of the basket can be selected to be installed with a crawler type walking device or a multi-wheeled walking device. The device, the wheel is mounted, the wheel of the wheel can be similar to the structure of the wheel 9, and the colleague can also install the wheel 94012, which can adopt the multi-wheel type walking device as claimed in the preceding claim, and the screw hole is arranged on the frame, and the screw hole and the cradle are arranged. Corresponding to the screw hole in the car or crib, screw the bolt or screw into the screw hole. After tightening, you can see the basket or the body fixed on the body of the bassinet or the stroller or crib, The real-time payment device is a smart phone with a one-click payment function that installs a real-time payment system. The multi-wheeled traveling device means that both the left and right train wheels are installed in an asymmetric manner, and the wheel mounting position on each side of the wheel is pushed forward or backward by a distance of half a wheel diameter from the mounting position of the opposite side wheel. In the multi-wheel type traveling device, one or more wheel wheels may be connected to an electric drive device or a P drive axle of an internal combustion engine. The anti-slip device is provided with a tab that can be extended or reset. When the user steps on the pedal of the anti-slip f device, the insert protrudes forward and is inserted into the groove of the axle, so that the axle no longer rolls, the brake vehicle is exercised, the axle stops rolling, and the wheel stops rotating. The small lamp has a screw hole on the outer casing, and the screw hole corresponds to a screw hole on the frame of the bassinet or the stroller or the crib or the cradle bed, and the screw or the screw is screwed, and the screw hole can be small. The lights are fixed in a bassinet or stroller or a crib or cradle bed. The hole diameter of the screw hole and the size of the screw or bolt match each other, so that the screw or bolt can be screwed inside the screw hole to fix the component on the bassinet or the cradle bed or the crib or the stroller.
